(19) United States
(12) Patent Application Publication
(10) Pub. No.: US 2011/0238975 A1
(43) Pub. Date: Sep. 29, 2011

(54) INFORMATION PROCESSING DEVICE, ROUTE CONTROL DEVICE, AND DATA RELAY METHOD

(75) Inventors: Kouichirou AMEMIYA, Kawasaki (JP); Kazumine Matoba, Kawasaki (JP); Kenichi Abiru, Kawasaki (JP)

(73) Assignee: FUJITSU LIMITED, Kawasaki-shi (JP)

(21) Appl. No.: 13/044,642

(22) Filed: Mar. 10, 2011

(30) Foreign Application Priority Data
Mar. 24, 2010 (JP) 2010-068719

(51) Int. Cl. H04L 9/00; G06F 15/16

(52) U.S. Cl. 713/150; 709/227

(57) ABSTRACT

A server notifies a route control device of a session ID indicating a session and generated for a user of a terminal device together with its own IP address. The terminal device notifies a route control device of data for a connection to a relay device together with a session ID. The route control device associates the data for the connection with the IP address of the server using the session ID, and sets the associated combination as relay setting information in the relay device. Thus, the relay device refers to the relay setting information using data for a connection extracted from a message when the message is received from the terminal device, and determines a destination of the message.

### CROSS-REFERENCE TO RELATED APPLICATIONS

This application is based upon and claims the benefit of priority of the prior Japanese Patent Application No. 2010-068719, filed on Mar. 24, 2010, the entire contents of which are incorporated herein by reference.

### FIELD

The embodiment described below relates to the technology of a user of a terminal device over a communication network.

### BACKGROUND

Presently, a communication network represented by the Internet has become widespread in the world, and various services for a user, as a client, of a terminal device connected to the communication network have been provided using a server.

The server for providing a service generates a session according to a message received from the terminal device, and provides the service for the user of the terminal device. The session corresponds to a unit of providing the service from the server to one terminal device. The server which has generated the session inserts a session ID as an identifier for identification of the generated session into a message as a response to the terminal device, and transmits the message to the terminal device. After the terminal device has received the message into which the session ID is inserted, it transmits a message into which the session ID is inserted to the server. Thus, the server can continue providing services based on the session ID in the message received from the terminal device.

Normally, it is anticipated that a large number of users use a service provided over a communication network. The more users use the service, the heavier the load of the server becomes. Therefore, the provider normally adopts the system configuration for performing load balancing in which a plurality of servers are prepared, and one of the servers is allocated as a server for providing a service for a user of a terminal device. A relay device for relaying data for the load balancing is normally referred to as an SLB (server load balancer).

The relay device stores the information about the relationship between the session ID and the server holding the session to which the session ID is assigned. Thus, when the relay device receives a message into which the session ID is inserted, it confirms whether or not it stores the information having the session ID, and determines a server to which a message is to be allocated depending on the confirmation result. The determined server to which the message is to be allocated is specified if the information having the session ID is stored. If the information having the session ID is not stored, a server is selected by an autonomous allocation algorithm such as a round robin algorithm etc. Thus, by determining a server to which a message is to be allocated, the relay device realizes a uniqueness guarantee by which a related message transmitted from the same terminal device is allocated to the same server. The function of realizing the uniqueness guarantee is referred to as a uniqueness guarantee function (or a session maintaining function). The information for use in realizing the uniqueness guarantee is hereinafter referred to as “uniqueness guarantee information”.

Recently, the concealment of a message is desired to protect against the leak of information related to privacy. The security of the concealment is normally realized by encrypting data. As the communication protocol for encrypting and communicating data, an SSL (secure socket layer) is widely used.

FIGS. 1A and 1B are explanatory view of the configuration of a message communicated over a communication network. The message illustrated in FIGS. 1A and 1B is an HTTP message when an HTTP (hypertext transfer protocol) is used. FIG. 1A is a configuration of a non-encrypted message. FIG. 1B is a configuration of a message encrypted by the SSL.

A message transferred over a communication network is basically configured by “header+payload”. A header includes necessary information for transfer of a message (packet), and a payload includes information to be practically transferred. In an HTTP message using the HTTP, an IP header (Internet protocol) and a TCP (transmission control protocol) header are stored as headers as illustrated in FIG. 1. The data of the layer above the TCP/IP, that is, an HTTP header and an HTTP body are stored as a payload in a message. In the HTTP body, data to be practical transferred is stored.

An IP header stores a source IP address indicating the source of a message, and a destination IP address indicating the destination of the message. A TCP header stores a source port number indicating the subaddress of the source IP address, and a destination port number indicating the subaddress of the destination IP address.

The location in a message in which a session ID is stored is normally defined for each communication protocol. In the HTTP message, the location in which the session ID is stored is a cookie field of the HTTP header. Therefore, when a relay device receives an HTTP message from a terminal device, it confirms the data of the cookie field of the HTTP header, and determines the server for transferring the HTTP message.

As illustrated in FIG. 1B, in the encryption by the SSL, the HTTP header and the HTTP body as a payload of the HTTP message are encrypted. Therefore, conventionally, the payload of the HTTP message received by the relay device is decoded, and the data of the cookie field of the HTTP header is confirmed, thereby realizing the uniqueness guarantee.

In the communication of a message using the SSL, an SSL session ID as an identification number is assigned by the establishment of the communication (session) using the SSL. It is not desired that the SSL session ID is used in realizing the uniqueness guarantee because the SSL session is established independently of the session of a server. That is, it is not guaranteed that an SSL session is necessarily maintained while the session of a server is maintained. Therefore, conventionally the uniqueness guarantee is realized by decoding a payload.

The load of a relay device increases by decoding the payload of a received HTTP message. The increase of the load incurs disadvantages such as the degradation of the quality of a service with a longer time taken to transfer a message, an increasing number of required relay devices, etc. Accordingly, it is important to suppress the growth of a load in a relay device.

### SUMMARY

In a system according to the present invention, an information processing device confirms the presence/absence of session data received from a server, the information processing device generates connection data when there is session data, the information processing device extracts session data and connection data at a route control device, the route control device extracts a server address of a server based on the received session data, the route control device transmits the connection data and the server address to a relay device, the information processing device encrypts transmission data and session data to be transmitted to the server thereby generating encryption data when the information processing device receives a notification of the completion of the relay setting of the relay device from the route control device, the information processing device transmits a message including a connection data and encryption data to the relay device, the relay device extracts a server address based on the connection data in the received message, and the relay device transmits the message to the extracted server address.

When the aspect of the embodiment is applied, the uniqueness guarantee can be realized without decrypting the payload of a message during a relaying process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIGS. 1A and 1B are explanatory views of a configuration of a message communicated over a communication network;

FIG. 2 is a configuration of a terminal device according to the first embodiment and a service providing system capable of using a service through the terminal device;

FIGS. 3A and 3B are explanatory views of a configuration of a message transmitted from a terminal device;

FIG. 4 is an explanatory view of a configuration of a message transmitted from a terminal device to a route control device;

FIGS. 5A and 5B are explanatory views of a message transferred from a relay device to a server;

FIG. 6 is an explanatory view of a message transferred from a relay device to a terminal device;

FIG. 7 is an explanatory view of a configuration of a message transmitted from a server to a relay device;

FIG. 8 is an explanatory view of a configuration of a message transmitted from a server to a route control device;

FIG. 9 is an explanatory view of a configuration of a message transmitted from a route control device to a relay device;

FIG. 10 is an explanatory view of data stored in one entry of a session ID table;

FIG. 11 is an explanatory view of data stored in one entry of a relay setting table;

FIG. 12 is an explanatory view of data stored in one entry of a session table;

FIG. 13 is an explanatory view of data stored in one entry of a setting management table;

FIG. 14 is an explanatory view of the process realized by each dedicated program of a terminal device, a relay device, a server, and a route control device;

FIG. 15 is a flowchart of a request transmitting process;

FIG. 16 is a flowchart of a response acquiring process;

FIG. 17 is a flowchart of server processing;

FIG. 18 is a flowchart of a server side session information collecting process;

FIG. 19 is a flowchart of a client side session information collecting process

FIG. 20 is a flowchart of a setting accepting process;

FIG. 21 is a flowchart of a primary signal request process;

FIG. 22 is a flowchart of a primary signal response process;

FIG. 23 is an example of a hardware configuration of a computer to which the present embodiment is applicable;

FIG. 24 is a configuration of a terminal device according to the second embodiment and a service providing system capable of using a service through the terminal device;

FIG. 25 is a configuration of a terminal device according to the third embodiment and a service providing system capable of using a service through the terminal device;

FIG. 26 is an explanatory view of the data stored in one entry of a session information management table;

FIG. 27 is an explanatory view of the data stored in one entry of a hook target list;

FIG. 28 is an explanatory view of the data stored in one entry of a message buffer table;

FIG. 29 is an explanatory view of the data stored in one entry of a connection ID mapping table;

FIG. 30 is an explanatory view of the data stored in one entry of a SSL session ID mapping table;

FIG. 31 is an explanatory view of the data stored in one entry of a connection management table;

FIG. 32 is an explanatory view of the process realized by a program executed by a terminal device 1 according to the third embodiment;

FIG. 33 is a flowchart of the request transmitting process according to the third embodiment;

FIG. 34 is a flowchart of a communication path establishment requesting process;

FIG. 35 is a flowchart of a substitute requesting process;

FIG. 36 is a flowchart of a substitute response process;

FIG. 37 is a flowchart of a connection deleting process;

FIG. 38 is a flowchart of a session information storing process; and

FIG. 39 is a flowchart of a session information notifying process.

### DESCRIPTION OF EMBODIMENTS

The embodiments of the present invention are described below in detail with reference to the attached drawings.

### First Embodiment

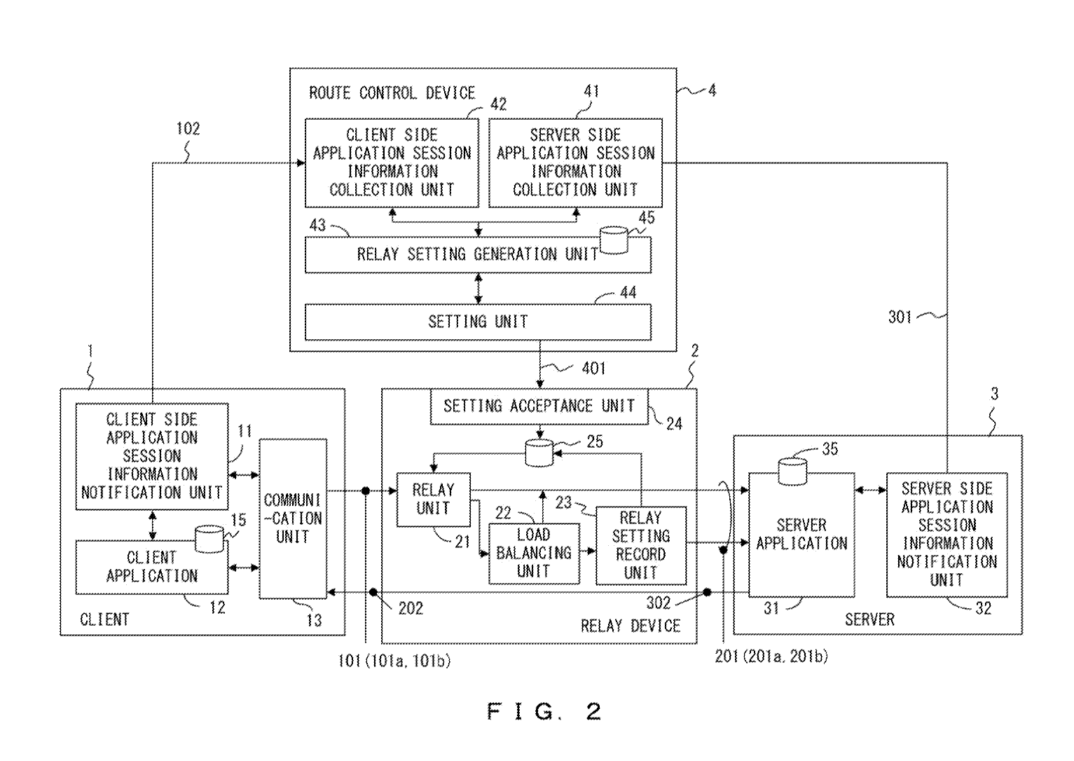

FIG. 2 is a configuration of a terminal device according to the first embodiment and a service providing system capable of using a service through the terminal device. The service providing system is configured using the relay device according to the first embodiment. For example, one or more relay device 2, two or more servers 3, and one route control device 4 are connected over a communication network not illustrated in the attached drawings. FIG. 2 illustrates one relay device 2 and one server 3 only for convenience.

Each server 3 provides a service for a user of the terminal device 1 as a client by executing a server application 31 which is an application program. The relay device 2 relays a message between the terminal device 1 and the server 3. When a message 101 is received from the terminal device 1, the server 3 to which the message 101 is to be transferred is determined, and the message 101 is transferred to the determined server 3.

Each server 3 generates a session by receiving the message 101 from the terminal device 1 through the relay device 2. In this case, the server 3 assigns to the generated session a session ID as an identifier for identification of the session. The session ID is inserted into a message 302. When the terminal device 1 continuously uses the service, it transmits the message 101 into which the session ID is inserted. Thus, the server 3 confirms whether or not the session ID is included in the message 101 received from the terminal device 1, and generates a session when the session ID is not included. Hereafter, just for convenience, the message 101 including no session ID, that is, the message which triggers the generation of a session, is referred to as a “initial message” and assigned a reference numeral of 101a. The message 101 including the session ID is assigned a reference numeral of 101b. The message 101 refers to the initial message 101a or the message 101b. A message for which it is not necessary to designate a source is assigned no reference numeral.

The terminal device 1 is a computer (information processing device having a communication function such as a mobile telephone, a PDA, a personal computer (PC), etc. The terminal device 1 stores a client application 12 as a program which enables a service provided by the server 3 to be used. The user of the terminal device 1 can use the service provided by the server 3 by executing the client application 12.

The server 3 and the terminal device 1 transmits a message after encrypting the payload of the message to guarantee the concealment of the message. The identifier of a session such as a session ID etc. is normally stores in the payload. Therefore, the relay device 2 cannot confirm the session ID without decoding the payload of a received message. If the session ID cannot be confirmed, the uniqueness guarantee for the transfer of the message 101b to the server 3 cannot be realized. However, the decoding process increases the load of the relay device 2. Thus, the present embodiment realizes the uniqueness guarantee without directing the relay device 2 to perform the decoding process.

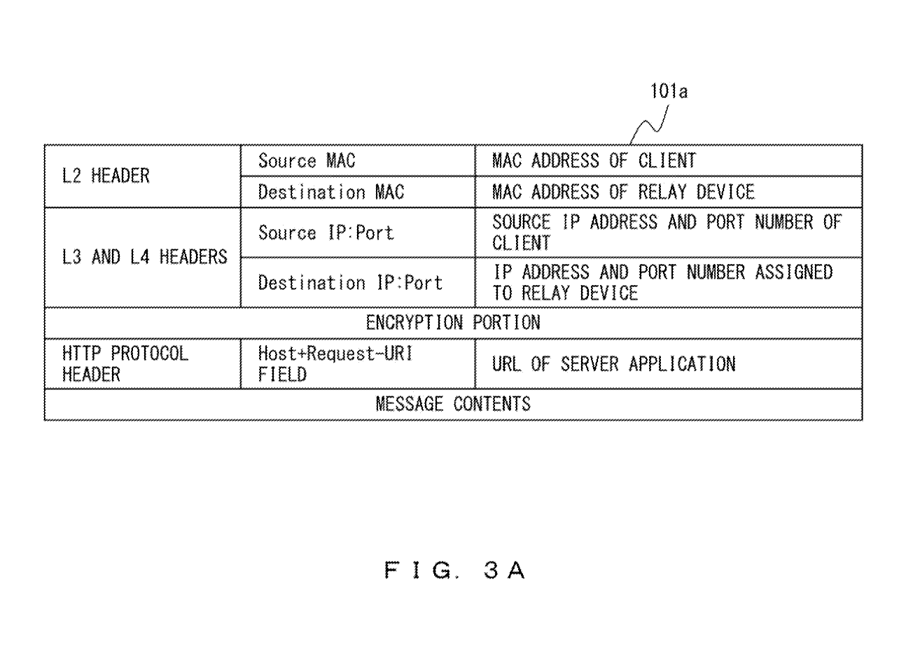

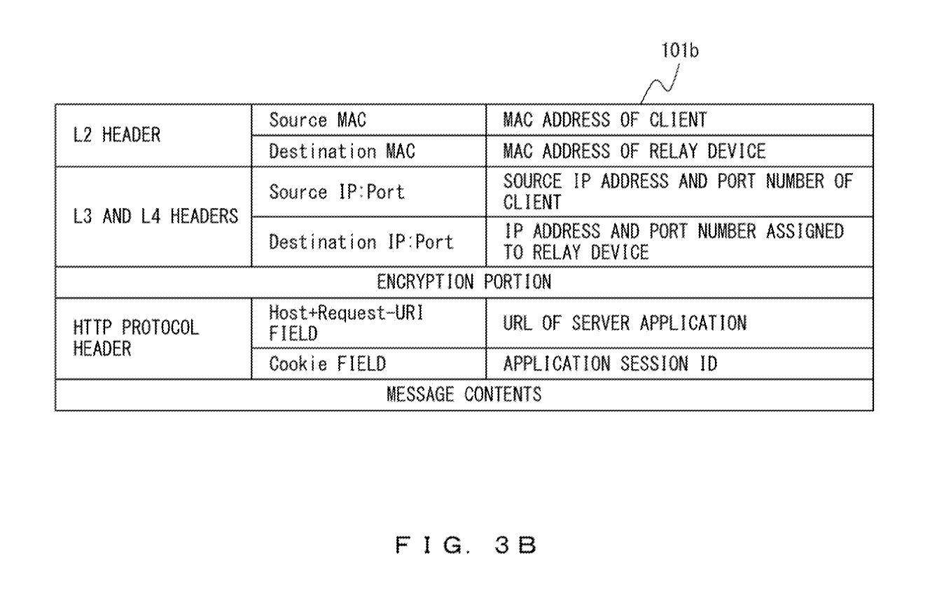

The route control device 4 provides the relay device 2 with the information which realizes the uniqueness guarantee (expressed by “relay setting information”) without decoding a payload. The relay setting information is generated using the information provided from the server 3 and the terminal device 1. The system of generating the relay setting information and the system of enabling the relay using the relay setting information are concretely described below with reference to FIGS. 3 through 13. In this embodiment, it is assumed that the terminal device 1 is connected to the relay device 2 and the route control device 4 through a LAN, and the relay device 2, each server 3, and the route control device 4 are connected to the LAN. The communication network can be other than a LAN, for example, a WAN, the Internet, etc.

The terminal device 1 which executes the client application 12 is provided with a client side application session information notification unit 11 and a communication unit 13. The communication unit 13 has the function of communicating a message through a LAN. The communication unit 13 encrypts and decodes the payload of the message 101.

FIGS. 3A and 3B are explanatory views of the configuration of the message transmitted from a terminal device. FIG. 3A is a configuration of the message before the establishment of a session in which a session ID is not inserted into the payload. FIG. 3B is a configuration of the message 101b after the establishment of a session in which a session ID is inserted into the payload.

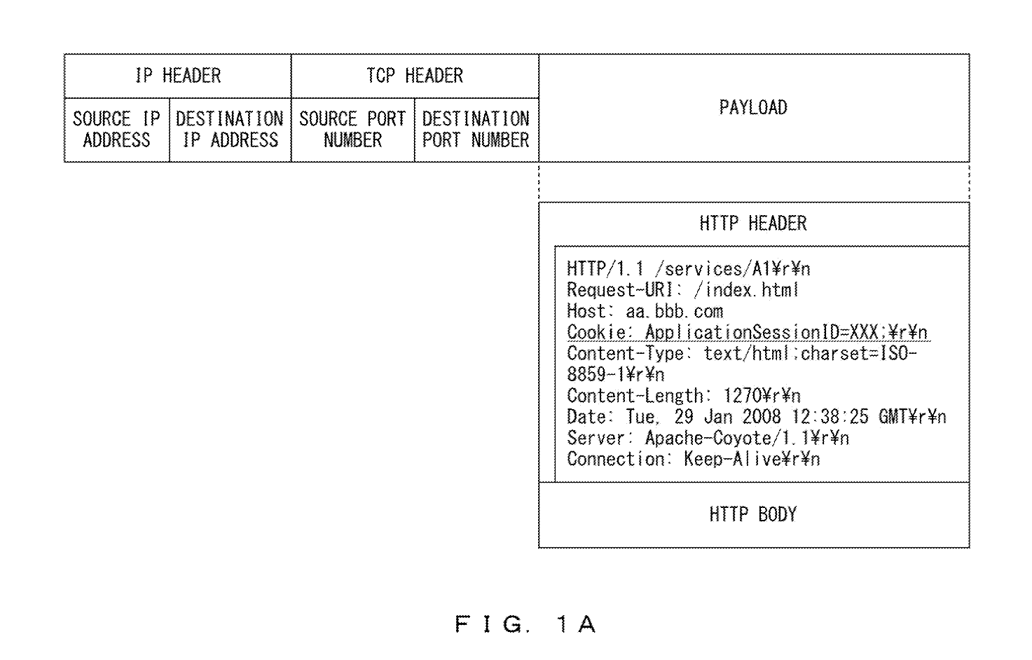

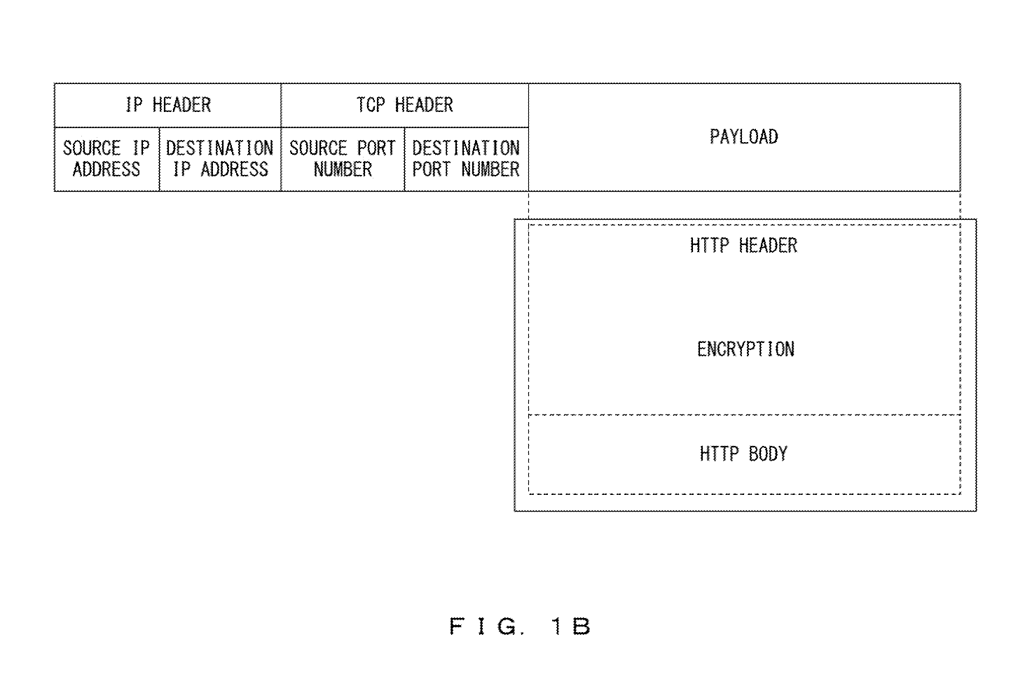

As illustrated in FIGS. 3A and 3B, the payload of the message 101 is the portion of the message excluding the L2 through L4 headers from the message. In the message 101 using the HTTP, the portion of the payload includes an HTTP header (expressed by “HTTP protocol header” in FIG. 3) and an HTTP body (expressed by “message contents” in FIG. 3) (refer to (b) in FIG. 1). The HTTP header includes a Host field and a Request-URL field. The server application 31 is specified by the URL indicated by the data stored in the fields. In the message 101b after the establishment of a session, the session ID is described as the data of the cookie field.

The L2 (layer 2) header is a header for transmission of data using a MAC (media access control address) address (Ethernet address) as a unique ID number of the equipment which can be connected to the Ethernet (LAN). The L2 header stores a source MAC address (Source MAC) and a destination MAC address (Destination MAC). The L3 and L4 headers are, for example, an IP header and a TCP header in the HTTP message in FIG. 1. Thus, the two headers represent a source IP address and port number and a destination IP address and port number.

The client application 12 manages a session ID table 15 storing a session ID. Each entry (record) of the session ID table 15 stores a session ID and a destination IP address. A destination IP address is associated with a session ID because the destination IP address is stored together with the session ID in the message 101. Since the message 101 is transferred to the server 3 through the relay device 2, the destination IP address is the IP address of the relay device 2.

Upon receipt of the response message 302 (transmitted to the terminal device 1 as a message 202 from the relay device 2) from the server 3, the client application 12 extracts a session ID from the message 302, and searches the session ID table 15. If an entry stored in the session ID table 15 cannot be extracted by the retrieval, one entry is added to the session ID table 15. The added entry stores the session ID and the source IP address (including the source port number in this example) in the message 302. The source IP address is stored as a destination IP address.

When transmitting the message 101, the client application 12 searches the session ID table 15 using the destination IP address (including the port number in this example) of the message 101 as a key, thereby confirming whether or not there is an entry storing the destination IP address. If it is confirmed that a corresponding entry exists, the session ID of the entry, it is reported together with the destination IP address, and the source IP address (including the port number in this example) to the client side application session information notification unit 11. The corresponding entry exists only when the message 101b is transmitted.

The client side application session information notification unit 11 notifies the route control device 4 of the session ID, the source IP address and port number, and the destination IP address and port number reported from the client application 12 as session information. The source IP address and port number and the destination IP address and port number are reported together with the session ID because the data can be used for identification of the connection (correspondence) for which the uniqueness guarantee is to be realized. Therefore, the combination of a source IP address and port number and a destination IP address and port number is hereinafter referred to as a “connection ID”. In the present embodiment, the IP address and port number of the terminal device 1 is used as a source IP address and port number, and the URL of the server application 31 expressed by the Host and Request-URL field is used as a destination IP address and port number.

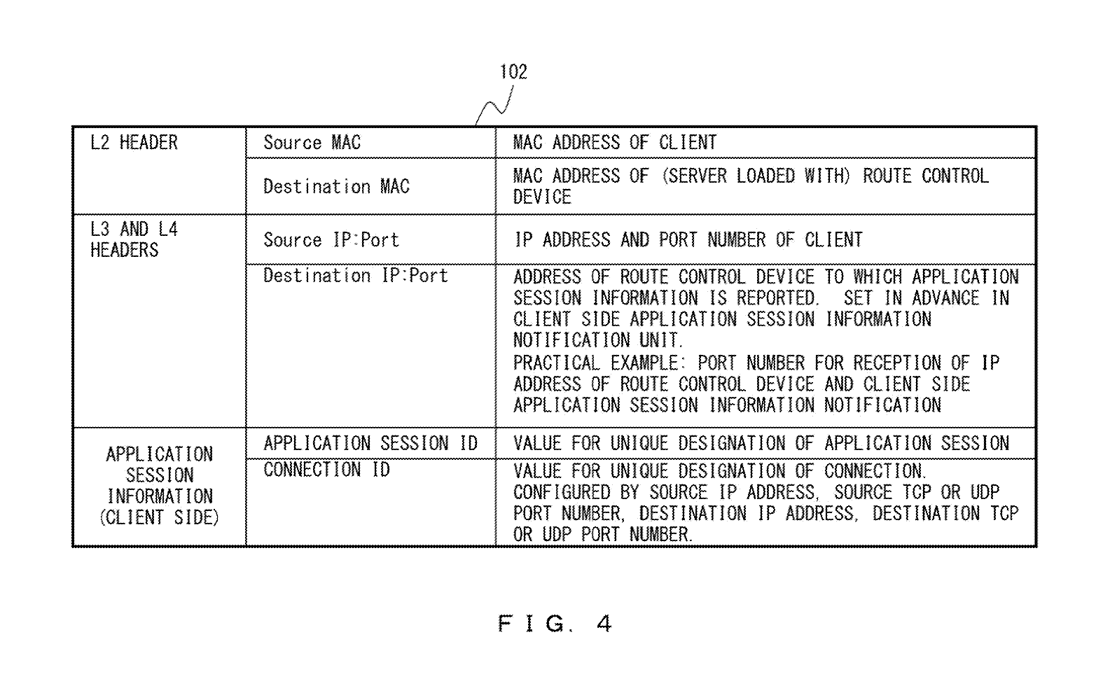

FIG. 4 is an explanatory view of a configuration of a message 102 to be transmitted for notification of the session information from the terminal device 1. As illustrated in FIG. 4, the L2 header stores the MAC address of the terminal device 1 as a source MAC address, and the MAC address of the route control device 4 as a destination MAC address. The L3 and L4 headers store the IP address and port number of the terminal device 1 as a source IP address and port number, and the IP address and port number of the route control device 4 as a destination IP address and port number. If the route control device 4 is loaded into a server, the IP address and port number of the route control device 4 is used as the IP address and port number of the server. In this example, it is assumed that the route control device 4 is realized as a dedicated device, that is, one server just for convenience. The session information is stored as the payload of the message 102.

The message 101 can be transmitted using a communication protocol other than the TCP. The communication protocol can be, for example, a UDP (user datagram protocol). Thus, in FIG. 4, the UDP is specified other than the TCP as a communication protocol for obtaining the port number of a connection ID.

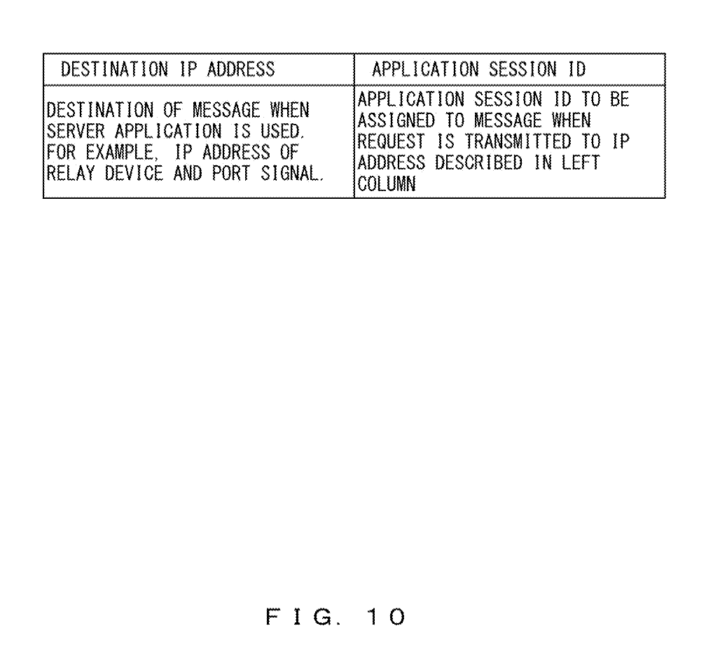

The client application 12 manages the session ID table 15 storing a session ID. Each entry (record) of the session ID table 15 stores the session ID and the destination IP address as illustrated in FIG. 10. The destination IP address is associated with the session ID because the destination IP address is data to be stored in the message 101 together with the session ID. Since the message 101 is transferred to the server 3 through the server 3, the destination IP address is the IP address of the relay device 2.

The relay device 2 changes the source MAC address of the L2 header of the message 101 received from the terminal device 1 into its own MAC address, and changes the destination MAC address into the MAC address of the server 3. It also changes the destination IP address and port number of the L3 and L4 headers into the IP address and port number of the server 3. A message 201 generated by performing the above-mentioned changes is transmitted. In this case, the server 3 which stores the destination IP address and port number in the L3 and L4 headers is selected by the autonomous allocation algorithm such as the round robin algorithm etc. if the received message 101 is the initial message 101a. If it is not the initial message 101a, the server 3 has an established session. The method of determining the server 3 having an established session is described later in detail.

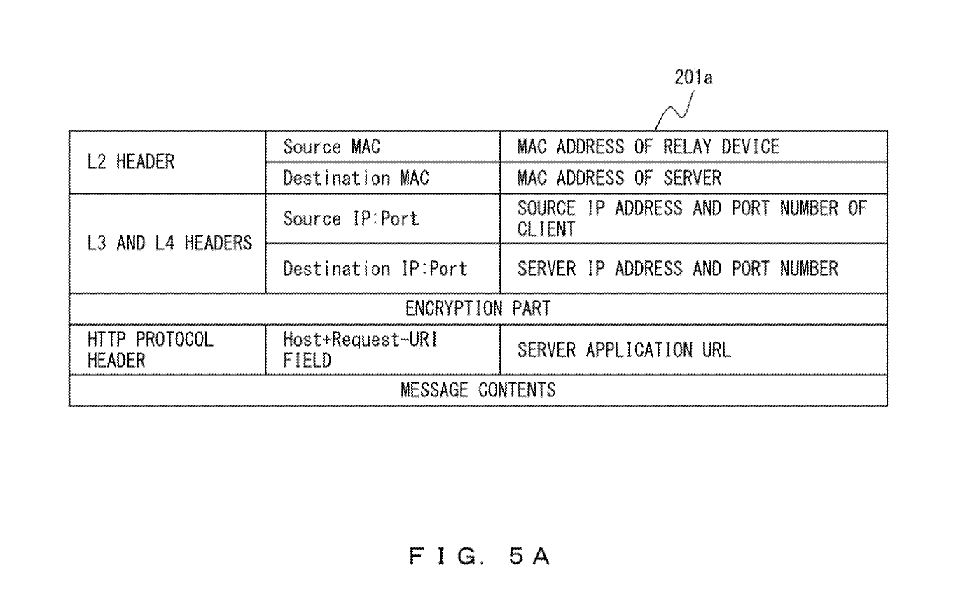

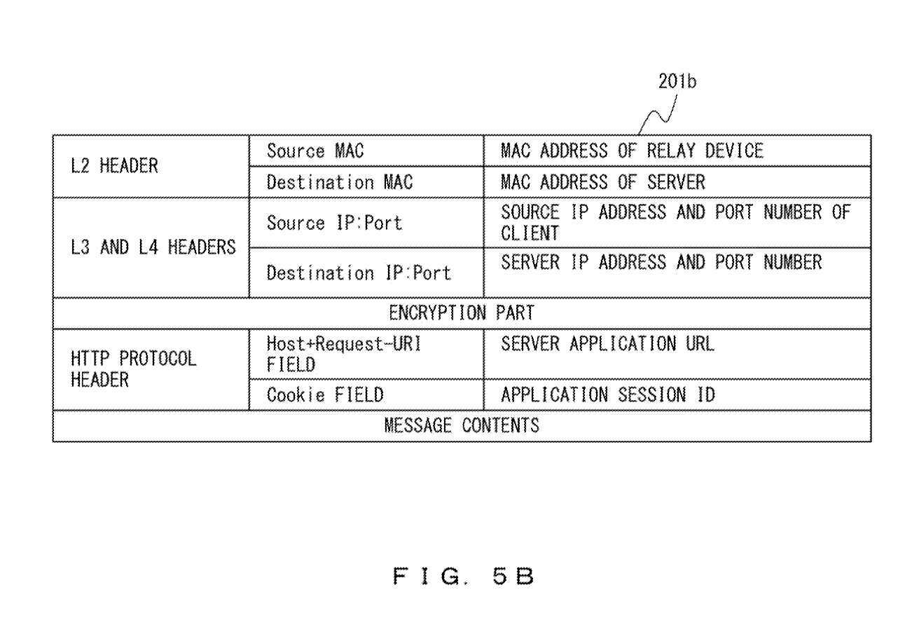

FIGS. 5A and 5B are explanatory views of a configuration of a message transferred from a relay device to a server. FIG. 5A is a configuration of the message 201 before the establishment of a session to be transferred upon receipt of the initial message 101a. FIG. 5B is a configuration of the message 201 to be transferred after the establishment of a session. In the following descriptions, when it is necessary to discriminate the message 201, the reference numeral of 201a is assigned to the message 201 before the establishment of a session, and the reference numeral of 201b is assigned to the message 201 after the establishment of a session. As illustrated in FIGS. 5A and 5B, the important difference between the messages 201a and 201b is the presence/absence of a session ID in the payload.

Upon receipt of the message 201 from the relay device 2, the server 3 decodes the payload of the message 201, and transmits the result to the server application 31. The server application 31 confirms whether or not there is a session ID in the payload, newly establishes a session if there is no session ID, and assigns a session ID to the session. It also generates and stores necessary information for providing a continued service.

In the present embodiment, a session table 35 is used in storing a session ID and information. Each entry (record) of the session table 35 stores necessary information (hereinafter referred to as “session-related information”) in providing a session ID and a service (performing a process by the server application 31). When the server 3 receives the message 201b without a session ID, the server application 31 updates the corresponding session-related information as necessary.

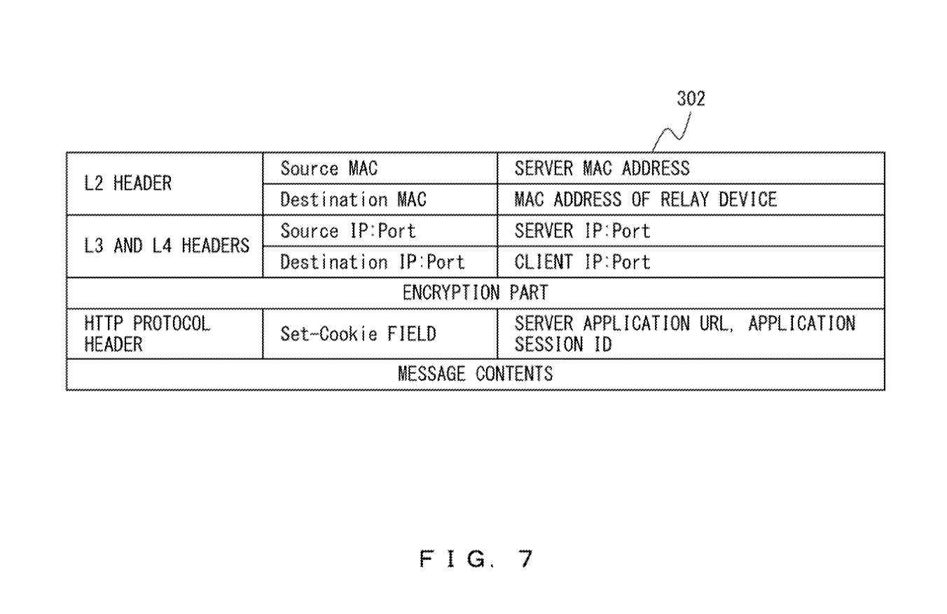

The server application 31 generates the message 302 storing the data requested by the received message 201 and the session ID in the payload, and transmits the message to the relay device 2. FIG. 7 is an explanatory view of a configuration of the message transmitted from a server. As illustrated in FIG. 7, the L2 header stores the MAC address of the server 3 as a source MAC address, and stores the MAC address of the route control device 4 as a destination MAC address. The L3 and L4 headers stores the IP address and port number of the server 3 as a source IP address and port number, and stores the IP address and port number of the terminal device 1 as a destination IP address and port number.

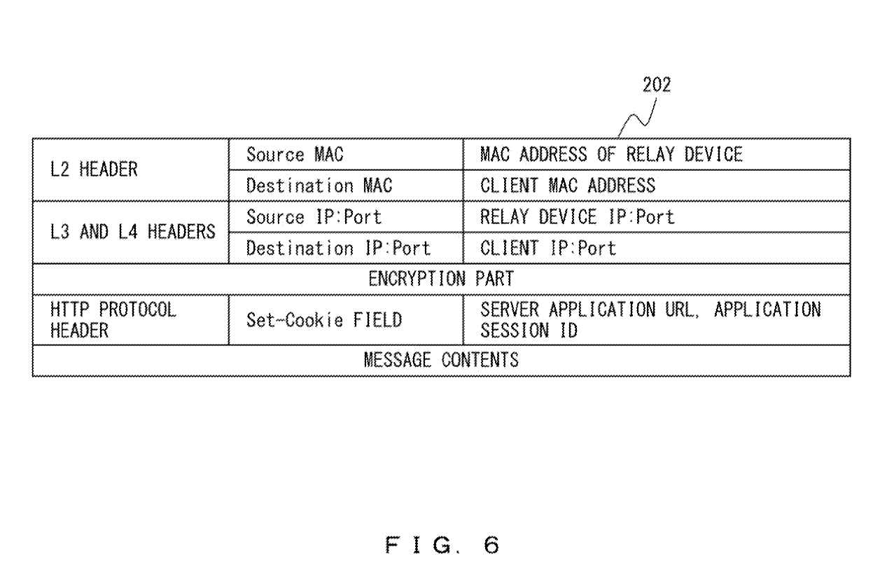

Upon receipt of the message 302 from the server 3, the route control device 4 changes the source MAC address of the L2 header into its own MAC address, and changes the destination MAC address into the MAC address of the terminal device 1. It also changes the source IP address and port number of the L3 and L4 headers into its own IP address and port number. By performing the changes, it generates the message 202 as illustrated in FIG. 6, and transmits the message to the terminal device 1. In this case, the MAC address of the terminal device 1 is specified from the destination IP address and port number stored in the L3 and L4 headers.

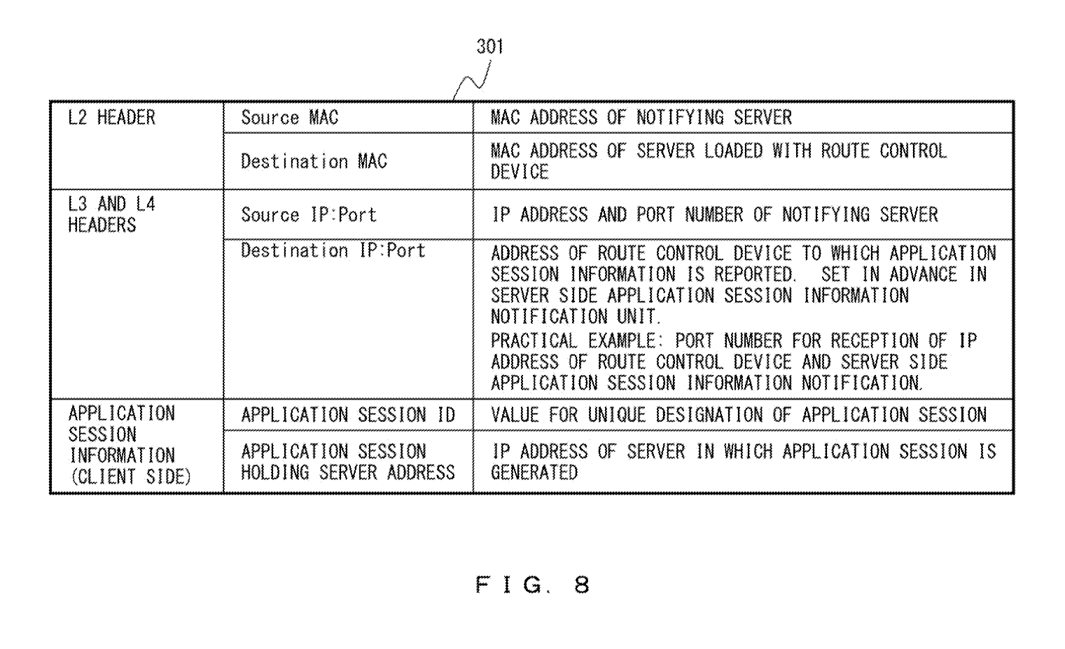

When the server application 31 newly generates a session, a server side application session information notification unit 32 of the server 3 notifies the route control device 4 of the session ID and the IP address and port number of the server 3 from which the service of the server application 31 is available (hereinafter expressed by a “server IP address”). The notification is performed by generating and transmitting a message 301 as illustrated in FIG. 8. The message 301 stores as a payload the session ID and the server IP address as session information. The server IP address stored in the payload does not necessarily match the source IP address and port number stored in the L3 and L4 headers. That is, they can be the same or different from each other.

The route control device 4 includes a server side application session information collection unit 41, a client side application session information collection unit 42, a relay setting generation unit 43, and a setting unit 44. The message 301 received from the server 3 is processed by the server side application session information collection unit 41, and the session information stored in the message 301 is extracted. Similarly, the message 102 received from the terminal device is processed by the client side application session information collection unit 42, and the session information stored in the message 102 is extracted. The session information extracted by the server side application session information collection unit 41 and the client size application session information collection unit 42 is output to the relay setting generation unit 43.

The relay setting generation unit 43 specifies the correspondence of the session information collected by the session information collection units 41 and 42 by the session ID. Thus, the server IP address and the connection ID assigned the same session ID are associated with each other. The relay setting information is generated by associating a server IP address with a connection ID. The generated relay setting information is output to the setting unit 44.

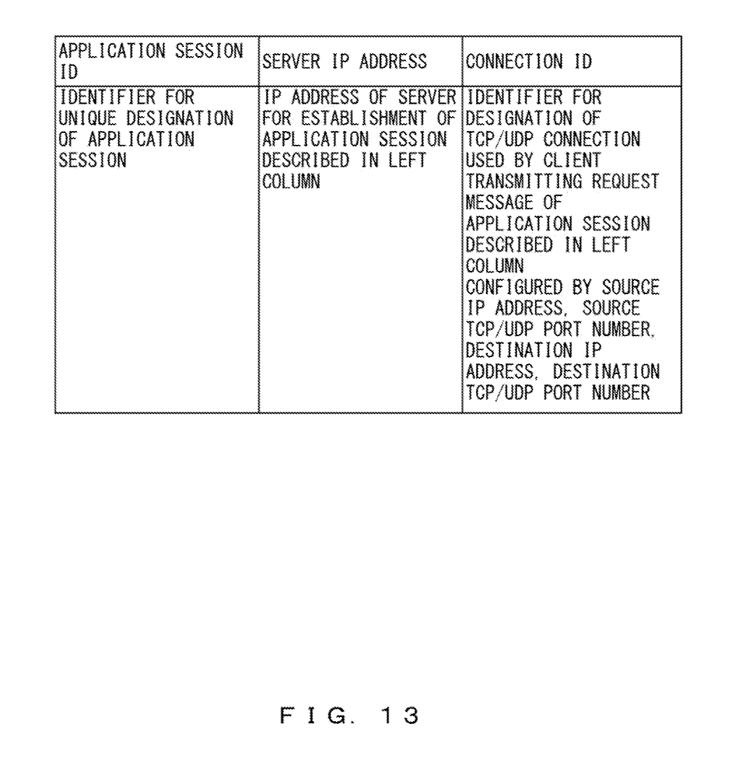

The relay setting generation unit 43 manages the generation of the relay setting information using a setting management table 45. Each entry (record) of the setting management table 45 can store a session ID in addition to the associated server IP address and connection ID as illustrated in FIG. 13. If the session information is input from one of the session information collection units 41 and 42 after receiving the message 102 or the message 301, the relay setting generation unit 43 refers to the server side application session information collection unit 41, and determines whether or not the relay setting information is to be generated. Thus, the relay setting information is generated only when the connection ID is reported from the terminal device 1 to the entry without a connection ID. When the relay setting information is generated, the connection ID is stored in the corresponding entry.

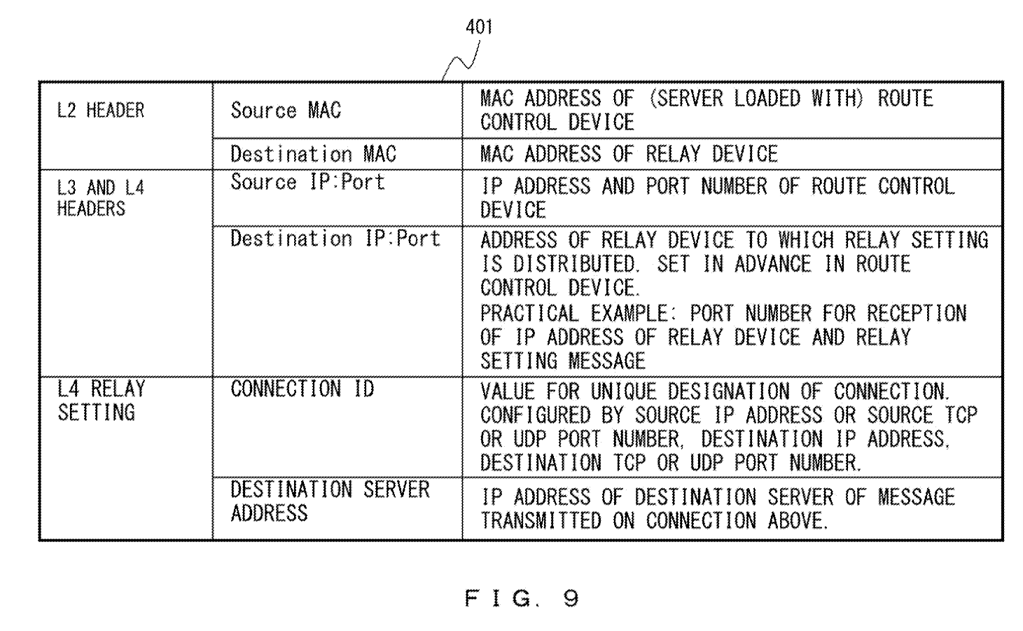

When the setting unit 44 receives the relay setting information from the relay setting generation unit 43, it generates a message 401 for notifying the relay device 2 of the relay setting information, and transmits the message to the relay device 2. The message 401 is configured as illustrated in FIG. 9, and the relay setting information is stored as a payload in the message 401.

The message 401 transmitted from the route control device 4 is processed by a setting acceptance unit 24 of the relay device 2. The setting acceptance unit 24 extracts the relay setting information from the message 401, and stores the extracted relay setting information in a relay setting table 25.

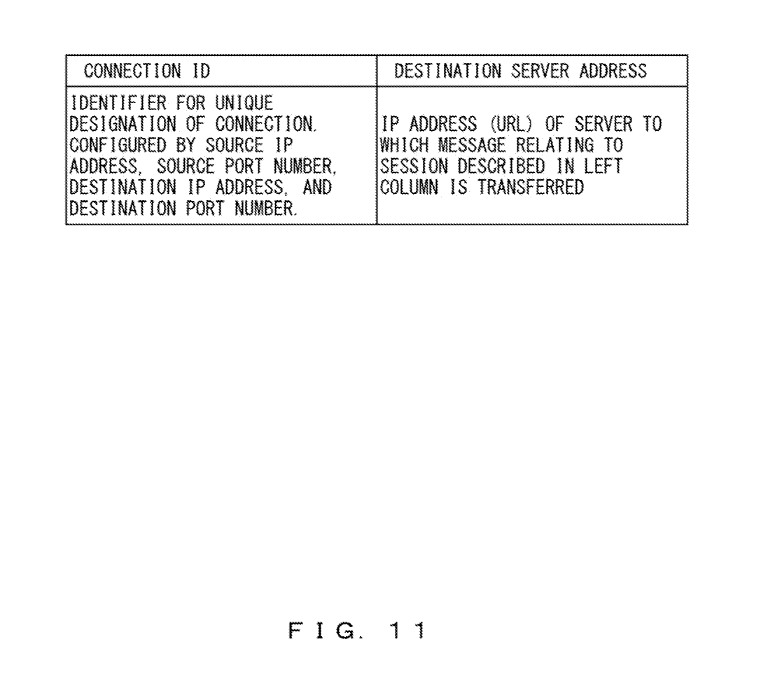

Each entry of the relay setting table 25 stores the relay setting information, that is, a connection ID and a server IP address as illustrated in FIG. 11. Thus, the setting acceptance unit 24 performs retrieval using the connection ID of the extracted relay setting information as a key, and stores the relay setting information depending on the retrieval result. If an entry is extracted by the retrieval, the entry is overwritten with the relay setting information. If no entry is extracted, one entry is added, and the added entry stores the relay setting information. Thus, there is only one entry that stores the same connection ID.

In addition to the setting acceptance unit 24, the relay device 2 includes a relay unit 21, a load balancing unit 22, and a relay setting record unit 23. These units 21 through 23 perform the following operations.

The relay unit 21 refers to the relay setting table 25 and realizes the relay of a message between the terminal device 1 and the server 3. When the message 101 is received from the terminal device 1, the source and destination IP addresses and port numbers are extracted from the L3 and L4 headers, and the relay setting table 25 is searched using as a key the combination of the extracted IP addresses and port numbers. If an entry storing the combination as a connection ID is extracted by the search, that is, the message 101 is the message 101b, the destination IP address and port number of the L3 and L4 headers are changed into the server IP address of the entry. The source and destination MAC addresses of the L2 header of the message 101b are respectively changed into the MAC address of its own, and the MAC address of the server 3 having the server IP address. By these changes, the message 201b is generated, and the message is transmitted to the server 3. If no entry is extracted, the message 101 is regarded as the initial message 101a, and is output to the load balancing unit 22.

The load balancing unit 22 selects the server 3 as a destination of the initial message 101a by the autonomous allocation algorithm, and stores the IP address and port number of the selected server 3 as the destination IP address and port number of the L3 and L4 headers, thereby generating the message 201a. The source MAC address of the L2 header is changed into the MAC address of its own, and the destination MAC address is changed into the MAC address of the selected server 3. The generated message 201a is transmitted to the server 3, and the relay setting record unit 23 is notified of the source and destination IP addresses and port numbers of the L3 and L4 headers of the initial message 101a, and the IP address and port number of the selected server 3.

The relay setting record unit 23 stores in the relay setting table 25 the source and destination IP address and port number reported by the load balancing unit 22 as a connection ID, and the IP address and port number of the server 3 as a server IP address. When the initial message 101a is received from the terminal device 1 as described above, the IP addresses and port numbers are reported from the load balancing unit 22. Thus, the relay setting record unit 23 adds one entry to the relay setting table 25, and the IP addresses and port numbers are stored as the relay setting information in the added entry.

Upon receipt of the message 302 from the server 3, the relay unit 21 rewrites the address and generate the message 202 as in the case when the message 101b is received. The source IP address and port number of the L3 and L4 headers of the message 302 are changed into its own IP address and port number, and the source and destination MAC addresses of the L2 header are respectively changed into their own MAC addresses and the MAC address of the terminal device 1. By these changes, the message 202 is generated and transmitted to the terminal device 1.

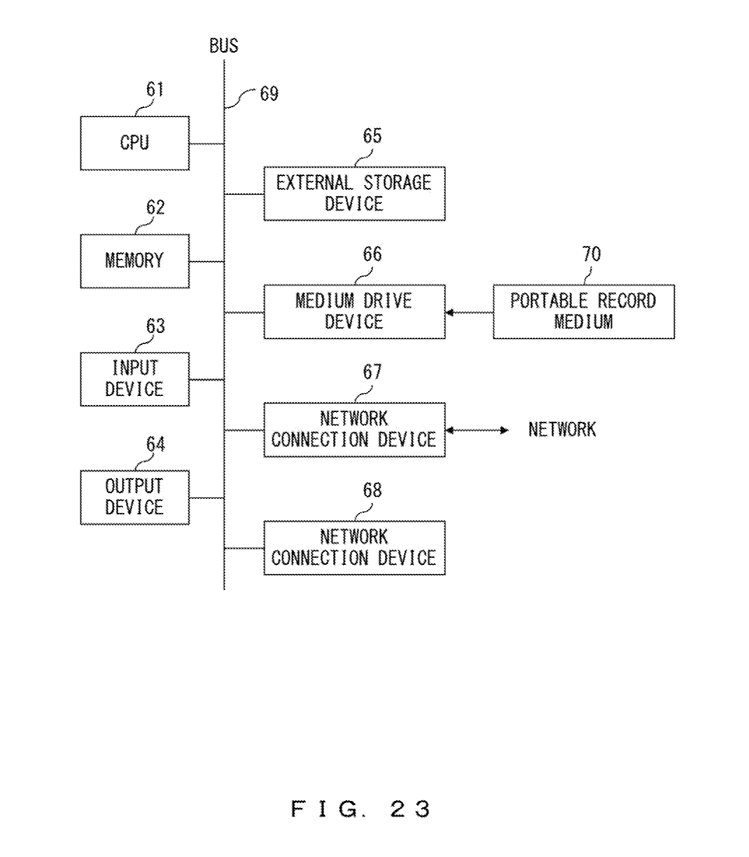

The terminal device 1, the relay device 2, the server 3, and the route control device 4 are operated by directing a computer to execute a dedicated program. The terminal device 1 is realized by directing the computer to execute the client application 12. The server 3 is realized by directing the computer to execute the server application 31. The relay device 2 is realized by executing a program for enabling the relay of a message (hereinafter referred to as a “relay program”), and the route control device 4 is realized by executing a program for setting the relay setting information in the relay device 2 (hereinafter referred to as a “route control program”). With reference to FIG. 23, a computer available as the terminal device 1, the relay device 2, the server 3, or the route control device 4 is concretely described below.

The computer illustrated in FIG. 23 has a CPU 61, memory 62, an input device 63, an output device 64, an external storage device 65, a medium drive device 66 and a network connection device 67, and they are interconnected through a bus 68. The configuration illustrated in FIG. 23 is an example, and is not limited to the example.

The CPU 61 controls the entire computer.

The memory 62 is semiconductor memory such as RAM etc. for temporarily storing a program or data stored in the external storage device 65 (or a portable record medium 70) when a program is executed and data is updated, etc. The CPU 61 reads the program to the memory 62 and executes the program, thereby controlling the entire processing.

The input device 63 enables data to be input through an operation device such as a keyboard, a mouse, etc. It can be an interface connectable to an operation device or includes an operation device and an interface. The operation of a user on an operation device is detected, and the detection result is reported to the CPU 61. The operation device can be a console etc.

The output device 64 is, for example, a display device, or a display control device connected to a display device. The external storage device 65 is, for example, a hard disk device, and is mainly used for storing various data and programs.

The medium drive device 66 is to access an optical disk, an magneto optical disk, or a portable record medium 70 such as a memory card etc. The network connection device 67 is to communicate with an external device over a communication network.

The dedicated program is recorded on the external storage device 65 or the portable record medium 70, or acquired by the network connection device 67 over a communication network. When it is assumed that the dedicated program is stored in the external storage device 65, each component of the terminal device 1, the relay device 2, the server 3, and the route control device 4 is realized by a combination of components of the computer as follows. The combination is read when it is assumed that the terminal device 1, the relay device 2, the server 3, and the route control device 4 are connected to the same communication network (LAN).

The client side application session information notification unit 11 of the terminal device 1 is realized by, for example, the CPU 61, the memory 62, the external storage device 65, the network connection device 67, and the bus 68. The session ID table 15 is stored in, for example, the external storage device 65, and is read to the memory 62 as necessary, and referenced or updated.

The relay unit 21, the load balancing unit 22, and the setting acceptance unit 24 of the relay device 2 are realized by, for example, the CPU 61, the memory 62, the external storage device 65, the network connection device 67, and the bus 68. The relay setting record unit 23 is realized by, for example, the CPU 61, the memory 62, the external storage device 65, and the bus 68. The relay setting table 25 is stored in, for example, the external storage device 65, read to the memory 62 as necessary, and referenced or updated.

The server side application session information notification unit 32 of the server 3 is realized by, for example, the CPU 61, the memory 62, the external storage device 65, the network connection device 67, and the bus 68. The session table 35 is stored in, for example, the external storage device 65, read to the memory 62 as necessary, and referenced or updated.

The server side application session information collection unit 41, the client side application session information collection unit 42, and the setting unit 44 of the route control device 4 are realized by, for example, the CPU 61, the memory 62, the external storage device 65, the network connection device 67, and the bus 68. When the communication network for connecting the route control device 4 to the terminal device 1 is different from the communication network for connecting the route control device 4, the relay device 2, and the server 3, the necessary connection devices for realizing the session information collection units 41 and 42 are different from one another. To be practical, the client side application session information collection unit 42 is realized using a necessary connection device 68 instead of the network connection device 67.

The relay setting generation unit 43 is realized by, for example, the CPU 61, the memory 62, the external storage device 65, and the bus 68. The setting management table 45 is stored in, for example, the external storage device 65, read to the memory 62 as necessary, and referenced or updated.

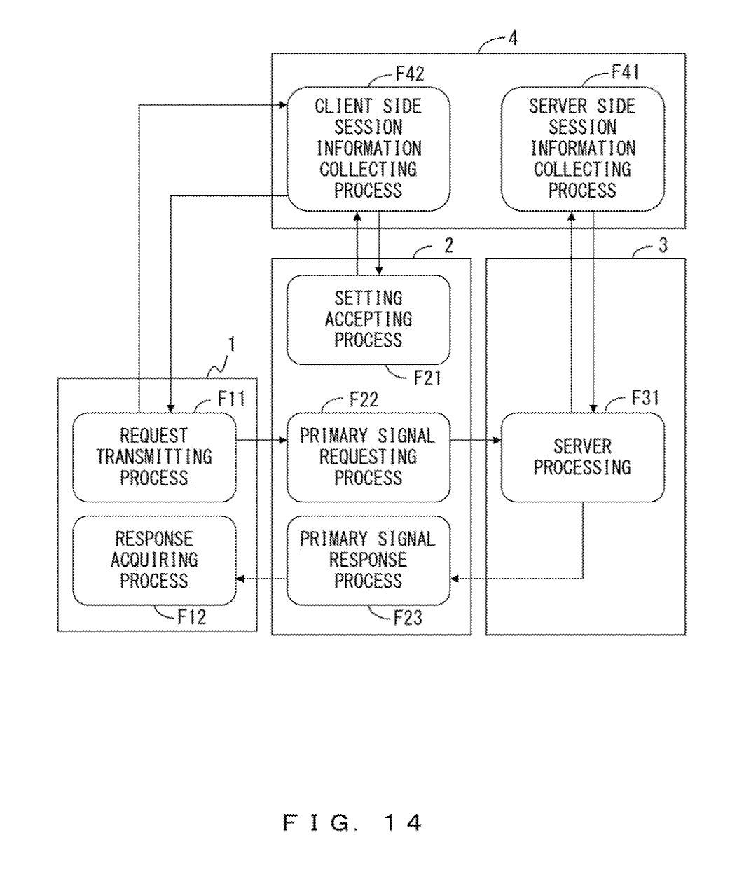

FIG. 14 is an explanatory view of the process realized by each dedicated program of the terminal device 1, the relay device 2, the server 3, and the route control device 4. In FIG. 14, the processes realized by the dedicated programs of the devices 1 through 4 are illustrated separately by situation for convenience. The process realized by the dedicated program of each of the devices 1 through 4 is described below with reference to FIG. 14.

The client application 12 as the dedicated program of the terminal device 1 realizes a request transmitting process F11 for transmitting the message 101 as any request. To process the message (message 202) transmitted as a response to the message 101, a client application 12 is realized.

The relay program as a dedicated program of the relay device 2 realizes a setting accepting process F21, a primary signal requesting process F22 and a primary signal response process F23. The setting accepting process F21 is performed to register the relay setting information transmitted from the route control device 4 in the relay setting table 25. The setting acceptance unit 24 is realized by performing the setting accepting process F21. The primary signal requesting process F22 is to process the message 101 received from the terminal device 1. A part of the relay unit 21, the load balancing unit 22, and the relay setting record unit 23 are realized by performing the primary signal requesting process F22. The primary signal response process F23 is performed to process the message 302 transmitted as a response from the relay device 2. The remaining part of the relay unit 21 is realized by performing the primary signal response process F23.

The server application 31 as a dedicated program of the server 3 realizes server processing F31 for processing the message 201 transferred from the terminal device 1 through the relay device 2.

The route control program as a dedicated program of the route control device 4 realizes a server side session information collecting process F41 and a client side session information collecting process F42. The server side session information collecting process F41 is performed for processing the message 301 transmitted from the server 3. The client side session information collecting process F42 is performed for processing the message 102 transmitted from the terminal device 1 and setting the relay setting information in the relay device 2. The server side application session information collection unit 41 is realized by performing the server side session information collecting process F41. The client side application session information collection unit 42, the relay setting generation unit 43, and the setting unit 44 are realized by performing the client side session information collecting process F42.

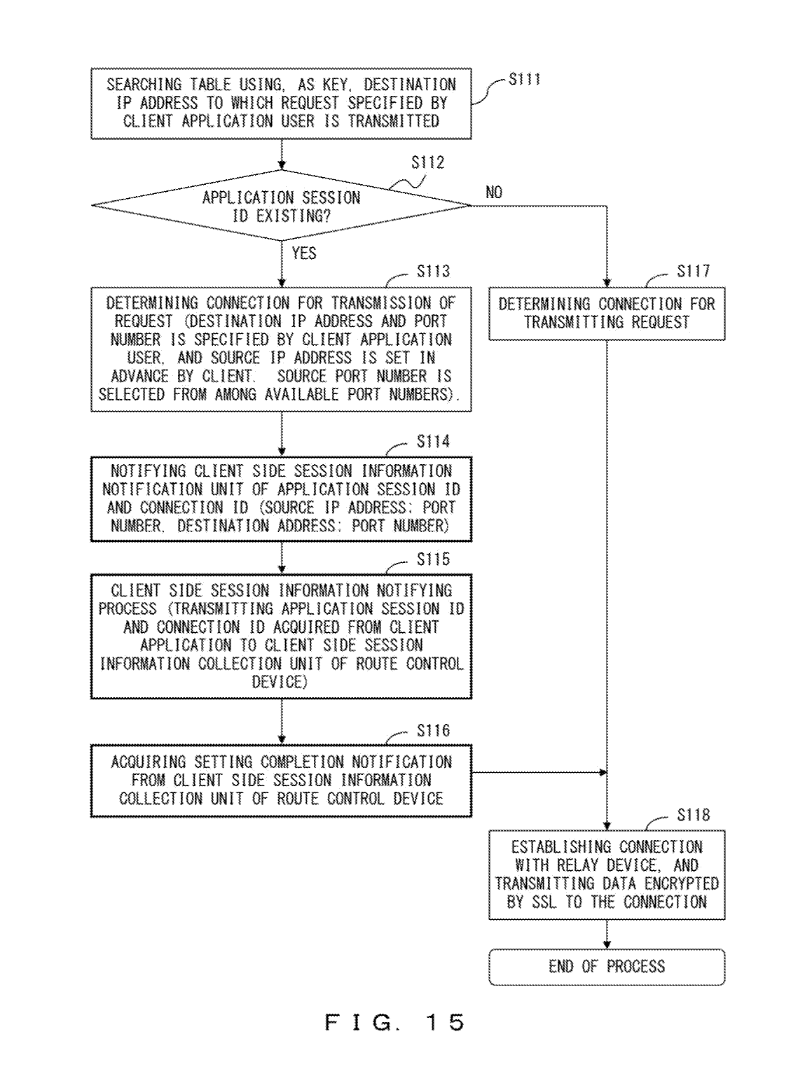

Each process in FIG. 14 is described below in detail with reference to each flowchart illustrated in FIGS. 15 through 22.

Described first in detail are the request transmitting process F11 and the response acquiring process F12 performed by the terminal device 1 using the client application 12.

FIG. 15 is a flowchart of the request transmitting process F11. The request transmitting process F11 according to the flowchart in FIG. 15 is triggered by an instruction of a user to access the service providing system, that is, to transmit the message 101 to the service providing system. The access instruction, that is, the specification of a URL, is carried out by inputting the URL or clicking the link with which the URL is associated. With reference to FIG. 15, the request transmitting process F11 is described in detail.

First, in step S111, the client application 12 searches the session ID table 15 (FIG. 10) using as a key the URL (destination URL) to which the user-specified message 101 is transmitted. In the next step S112, the client application 12 devices whether or not there is a session ID associated with the URL (IP address) as a key. If an entry storing the URL as a key can be extracted by the search, the determination is YES, and control is passed to step S113. If the entry cannot be extracted, the determination is NO and control is passed to step S117.

In step S113, the client application 12 determines the connection for transmitting a message (request). When the connection is determined, the URL specified by the user as a destination IP address and port number, the IP address preset in the terminal device 1 as a source IP address is selected, and one available port number is selected as a source port number. In the next step S114, the client application 12 passes the determined source IP address and port number, destination IP address and port number, and session ID as session information to the client side session information notifying process as an argument. In the next step S115, the client application 12 performs the notifying process.

The notifying process is to notify the route control device 4 of the session information. The generation of the message 102 illustrated in FIG. 4 and the transmission of the message to the route control device 4 can be realized by performing the notifying process. Upon receipt of the message 102, the route control device 4 returns to the terminal device 1a process completion response as a message notifying that the message 102 has been processed. Thus, after performing the client side session information notifying process in step S115, the client application 12 passes control to step S116, and awaits the acquisition of the process completion response from the route control device 4. After acquiring the process completion response, control is passed to step S118. The client side application session information notification unit 11 illustrated in FIG. 2 is realized by performing the processes in steps S115 and S116. These steps S115 and S116 are realized by the subprogram configuring the client application 12, that is, performed as a subroutine process.

In step S117 to which control is passed as a result of the determination in step S112, the client application 12 determines the connection for transmitting a message as in step S113. In the next step S118, the client application 12 establishes a connection with the relay device 2, and generates and transmits the message 101 by encrypting the payload. Then, it terminates the request transmitting process.

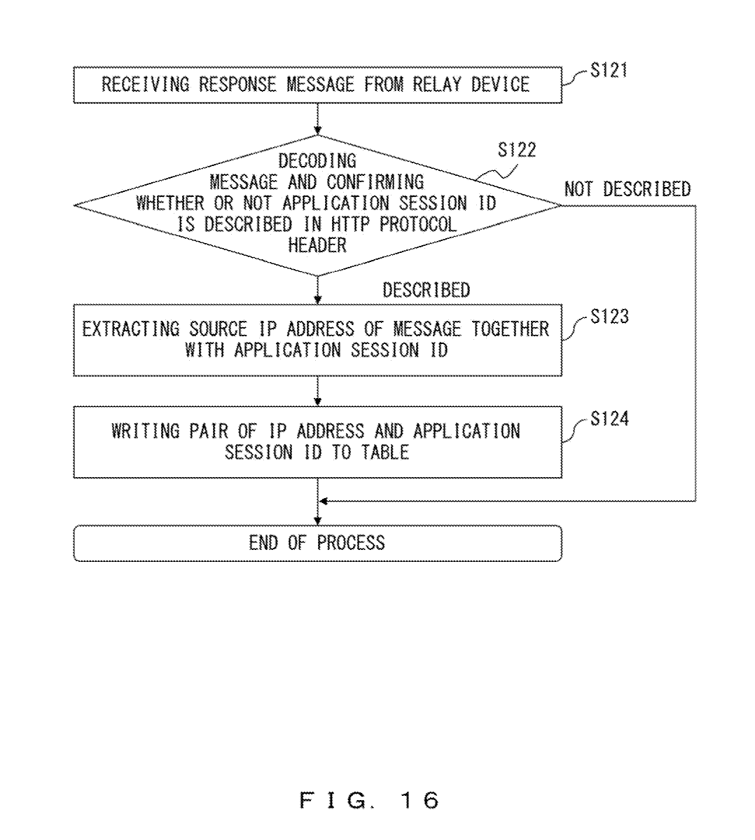

FIG. 16 is a flowchart of the response acquiring process F12. The response acquiring process F12 whose flowchart is illustrated in FIG. 16 is triggered by the reception of the message (response) 202 from the server 3 through the relay device 2. The response acquiring process F12 is described below in detail with reference to FIG. 16.

First in step S121, the client application 12 receives the message 202 received by the terminal device 1. In the next step S122, the client application 12 decodes the payload of the message 202, and confirms whether or not a session ID is stored in the HTTP header. When it is confirmed that no session ID is stored in the HTTP header, it is determined, thereby terminating the response acquiring process. On the other hand, when it is confirmed that a session ID is stored in the HTTP header, it is determined, and control is passed to step S123.

In step S123, the client application 12 extracts the session ID of the HTTP header, and the source IP address and port number (expressed by the “URL” in FIG. 16) of the L3 and L4 headers, and stores them in the session ID table 15. If the session ID table is searched using, for example, a session ID as a key, and a corresponding entry is extracted by the search, then the storing process is performed on the entry. If no entry is extracted in the search, one entry is added, and the process is performed on the added entry. Thus, after updating the session ID table 15, the response acquiring process terminates.

In the terminal device 1, the above-mentioned request transmitting process F11 and response acquiring process F12 are performed by the client application 12. When a service provided by the server 3 is used, the session information is reported to the route control device 4 by updating the session ID table 15 and generating and transmitting the message 102.

Next, the server processing F31 by the server 3 is described below in detail.

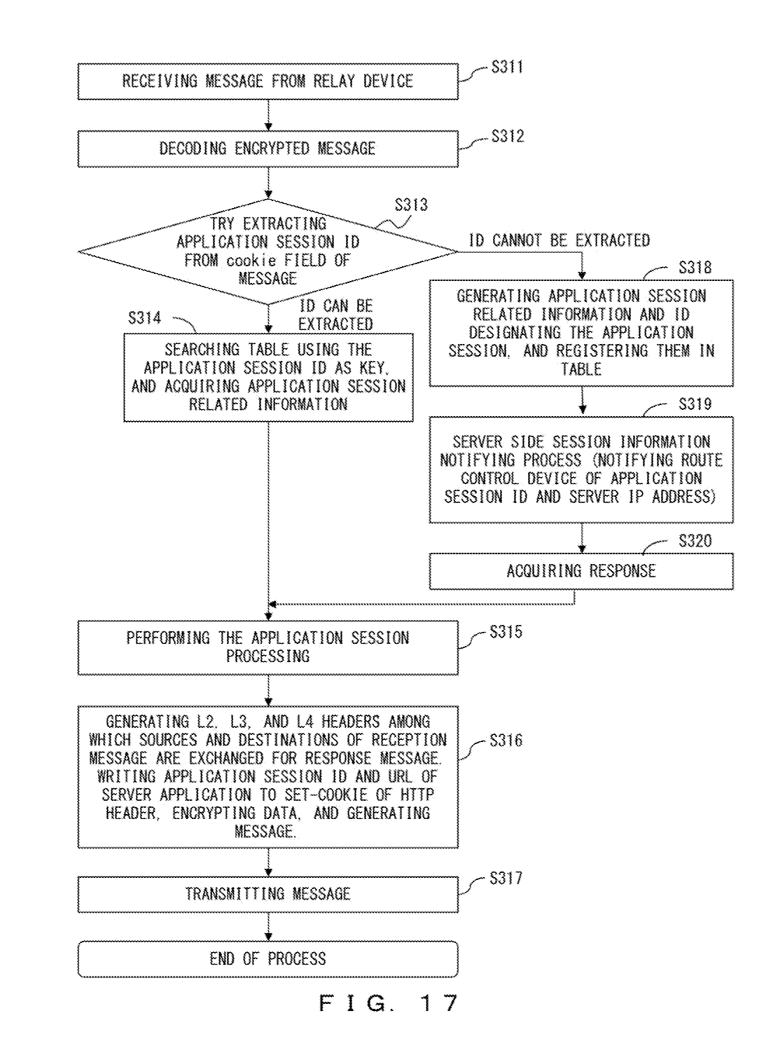

FIG. 17 is a flowchart of the server processing performed by the server 3 using the server application 31. The server processing is described below in detail with reference to FIG. 17. The flowchart illustrated in FIG. 17 is a flow of the process performed on the message 201 transmitted from the relay device 2.

First in step S311, the server application 31 receives the message 201 received by the server 3. In the next step S312, the server application 31 decodes the payload of the message 201. In the next step S313, the server application 31 confirms whether or not a session ID has been extracted from the cookie field of the HTTP header. If no session ID is extracted from the HTTP header, then it is determined, and control is passed to step S318. On the other hand, if a session ID can be extracted from the HTTP header, it is determined and control is passed to step S314.

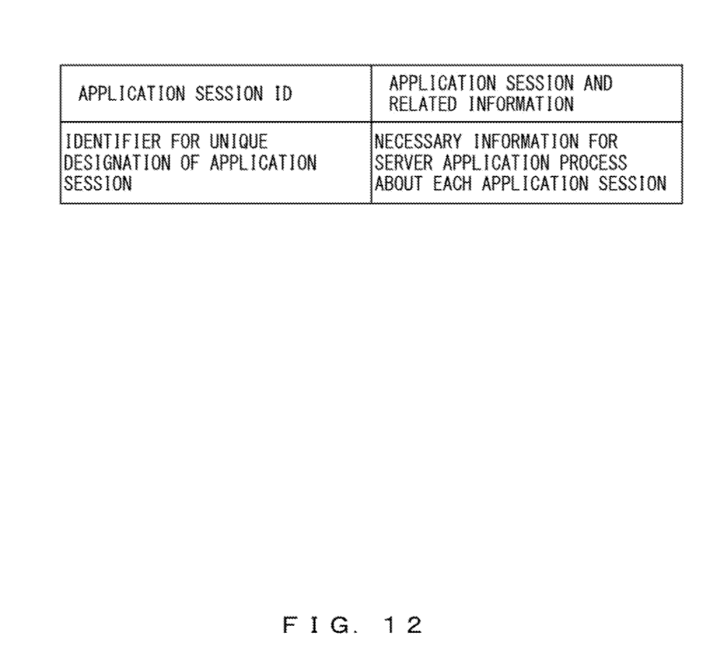

In step S314, the server application 31 searches the session table 35 (FIG. 12) using the extracted session ID as a key, and acquires the session-related information associated with the session ID. In the next step S315, the server application 31 performs the process (expressed by the “the application session process”) specified by the data in the payload using the acquired session-related information. Then, the server application 31 generates a response message 302 in step S316, and transmits the generated message 302 in the next step S317. After the transmission, the server processing terminates.

The message 302 is generated by exchanging the source and the destination of the L2 through L3 headers of the received message 201, and storing the session ID in the Set-cookie field (refer to FIG. 7) of the HTTP header, and the requested data in the HTTP body. The payload including the HTTP header and the body is encrypted. Thus, the message 302 as illustrated in FIG. 7 can be generated and transmitted.

In step S318 to which control is passed when it is determined in step S313 that no session ID can be extracted, the server application 31 generates session-related information and a session ID, and registers the data in the session table 35. The registering process is performed by adding one entry and storing the data in the added entry. In the next step S319, the server application 31 passes control to the server side session information notifying process (subprogram) as a subroutine process.

The subprogram acquires the IP address of the server 3 when control is passed from the server application 31, and notifies the route control device 4 of the address and the session ID. The notification is realized by generating the message 301 as illustrated in FIG. 8 and transmitting the generated message 301 to the route control device 4. After receiving the message 301, the route control device 4 returns a process completion response as a message indicating the process of the message 301 to the server 3. The control of the subprogram is returned to the server application 31 after the acquisition of the process completion response. The server side application session information notification unit 32 illustrated in FIG. 2 is realized by performing the subprogram, that is, the server side session information notifying process. Control is passed to the server application 31 after the acquisition of the process completion response in step S320, and the server application 31 which has received the control performs the process in step S315.

Described below in detail are the server side session information collecting process F41 and the client side session information collecting process F42 executed by the route control device 4 using the route control program.

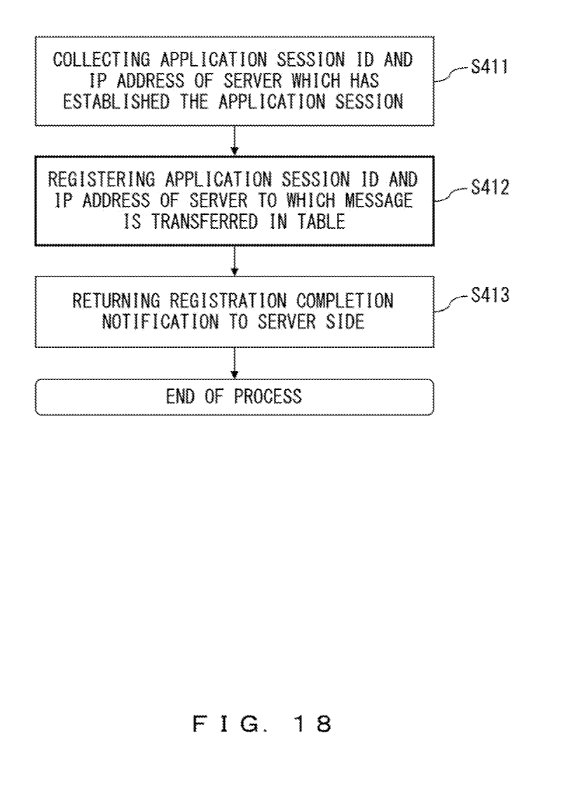

FIG. 18 is a flowchart of the server side application session information collection unit 41. The flowchart in FIG. 18 is a flow of the process on the message 301 received from the server 3. The collecting process F41 is described first below in detail with reference to FIG. 18.

First in step S411, the route control program collects from the payload of the received message 301 (FIG. 8) the session information, that is, the session ID and the IP address. In the next step S412, the route control program registers the collected session information in the setting management table 45. After the registration, control is passed to step S413, and the route control program returns a registration completion notification as a message notifying that the session information has been registered to the server 3 from which the message 301 has been received. Then, the server side session information collecting process F41 is terminated.

The registration of the session information is practically performed by searching the setting management table 45 using the session ID of the session information as a key, and confirming whether or not there is an entry extracted by the search. If an entry can be extracted, the entry is stored in the session information. If no entry is extracted, one entry is added, and the session information is stored in the added entry.

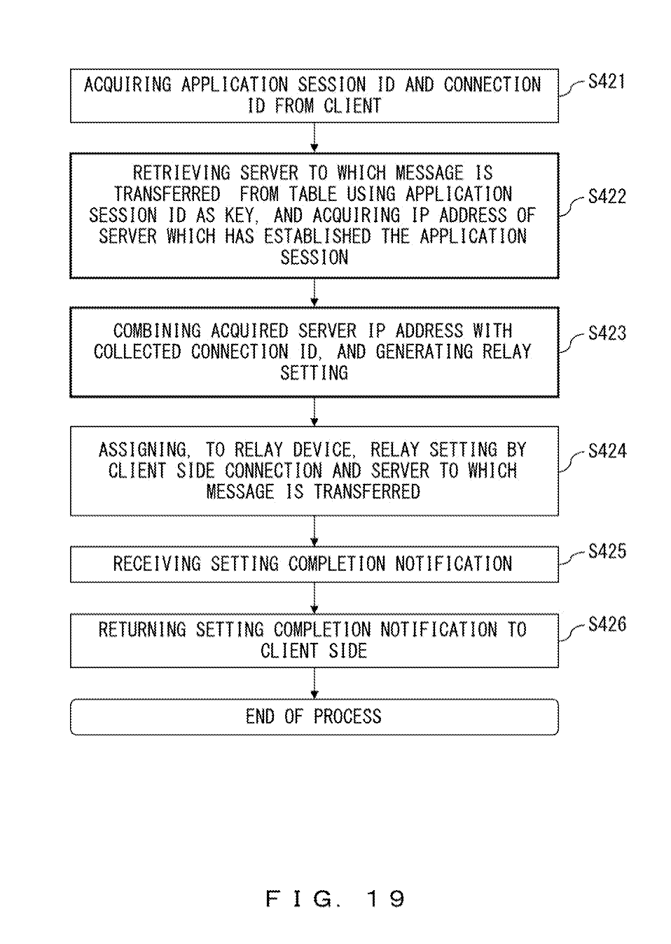

FIG. 19 is a flowchart of the client side session information collecting process F42. The flowchart in FIG. 19 is also a flow of the process performed on the message 102 received from the terminal device 1. Next, the collecting process F41 is described in detail with reference to FIG. 19.

First in step S421, the route control program collects the session information, that is, the session ID and the connection ID from the payload of the received message 102 (FIG. 4). In the next step S422, the route control program extracts one entry by searching the setting management table 45 using the session ID as a key, stores the connection ID in the entry, and acquires the IP address of the server 3 from the entry. Then, control is passed to step S423.

In step S423, the route control program generates relay setting information by combining the acquired IP address and connection ID. In the next step S424, the route control program generates the message 401 (FIG. 9) having the generated relay setting information stored in the payload and transmits the message to the relay device 2, thereby assigning the relay setting information. Then, the route control program waits for the reception, from the relay device 2, of a setting completion notification as a message reporting the completion of the settings of the relay setting information (step S425), and transmits to the terminal device 1 after the reception of the setting completion notification a setting completion notification as a message reporting the completion of the settings of the relay setting information (step S426). After the transmission of the setting completion notification, the client side session information collecting process F42 is terminated.

Thus, the setting completion notification to the terminal device 1 is transmitted after setting the relay setting information in the server 3. Therefore, the message 101b transmitted from the terminal device 1 after the reception of the setting completion notification is transferred to the server 3 to which the message is to be transferred by the relay device 2.

As described above, the client side session information collecting process F42 realizes the client side application session information collection unit 42, the relay setting generation unit 43, and the setting unit 44 of the route control device 4. To be more concrete, the client side application session information collection unit 42 is realized by performing the processes in steps S421 and S426. The relay setting generation unit 43 is realized by performing the processes in steps S422 and S423. The setting unit 44 is realized by performing the process in step S424.

Finally, the setting accepting process F21, the primary signal requesting process F22, and the primary signal response process F23 performed by the relay device 2 using the relay program are described below in detail.

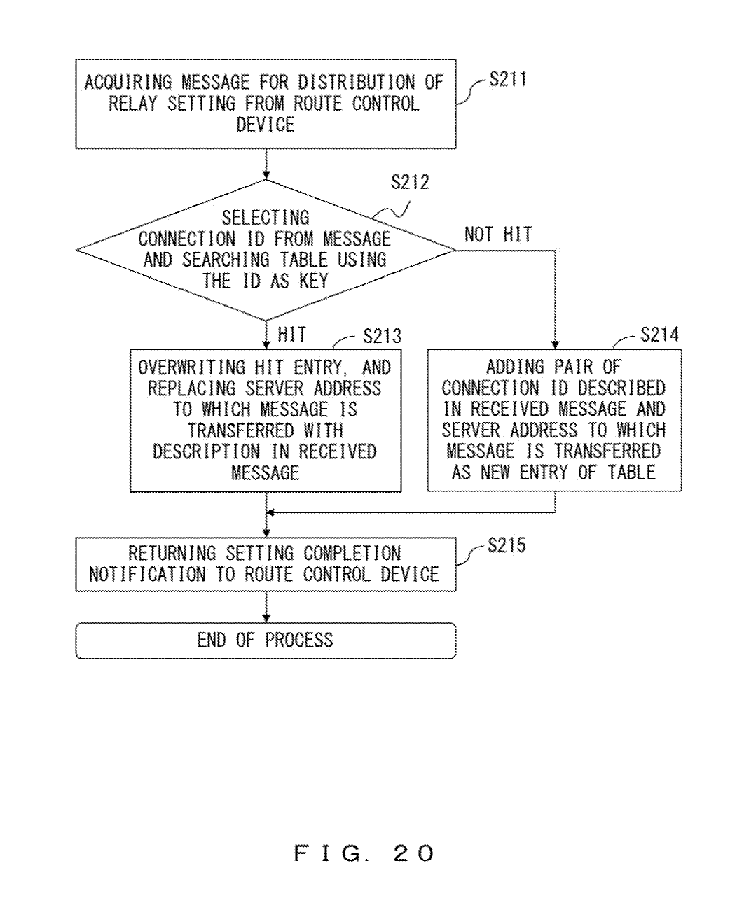

FIG. 20 is a flowchart of the setting accepting process F21. The flowchart in FIG. 20 is a flow of the process performed on one message 401 received from the route control device 4, that is, the flow of the process for setting a piece of relay setting information. In the process performed by the relay device 2, the setting accepting process F21 is first described in detail with reference to FIG. 20. As described above, the setting acceptance unit 24 in FIG. 2 is realized by performing the setting accepting process F21.

First in step S211, the relay program acquires the message (expressed as a “relay setting distribution message” in FIG. 20) 401 received from the route control device 4. In the next step S212, the relay program acquires the connection ID of the relay setting information stored in the payload of the message 401, searches the relay setting table 25 using the connection ID as a key, and determines the result of the search. If an entry storing the connection ID can be extracted as a result of the search, it is determined as a “hit”, and control is passed to step S213. On the other hand, if no entry is extracted, it is determined as “not hit”, and control is passed to step S214.

In step S213, the relay program overwrites the extracted entry with the IP address of the relay setting information. On the other hand, in step S214, the relay program adds one entry, and stores the relay setting information in the added entry, that is, stores the connection ID as a key and the IP address of the server 3 combined with the connection ID. After updating the relay setting table 25 by performing the process in step S213 or S214, control is passed to step S215, and the relay program returns to the route control device 4 a setting completion notification as a message reporting the completion of the settings of the relay setting information. After returning the notification, the setting accepting process is terminated.

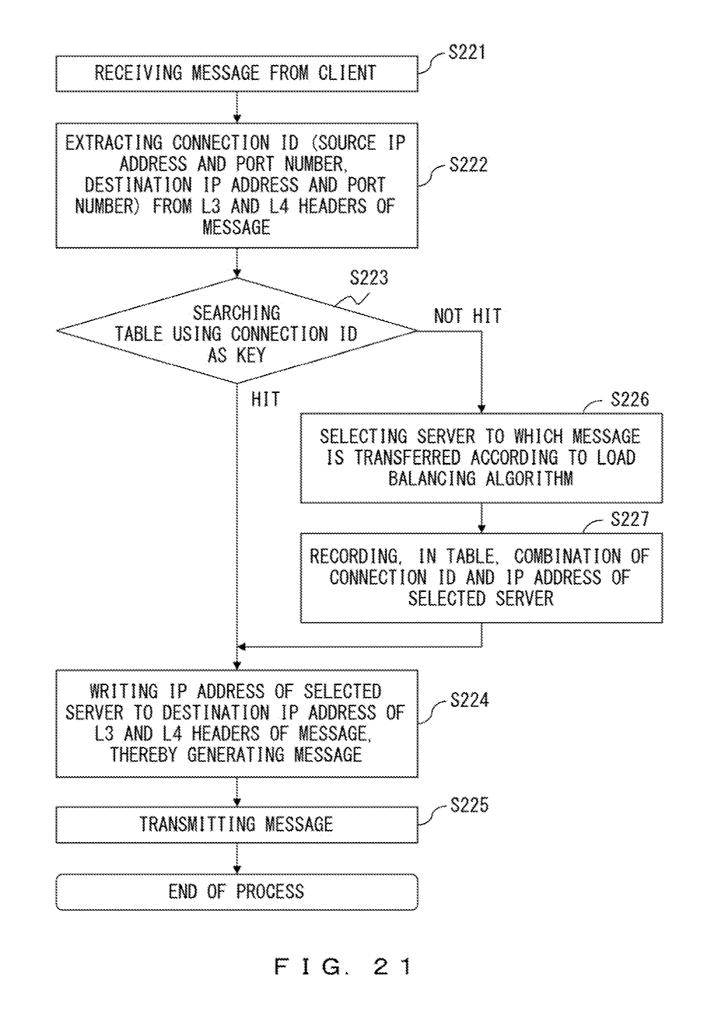

FIG. 21 is a flowchart of the primary signal requesting process F22. The flowchart in FIG. 21 is a flow of the process on one message 101 received from the terminal device 1. The primary signal requesting process F22 is described next in detail with reference to FIG. 21.

First in step S221, the relay program waits for the reception of the message 101 from the terminal device 1. Upon receipt of the message 101, control is passed to step S222, and the relay program extracts the connection ID, that is, the source IP address and port number and the destination IP address and port number, from the L3 and L4 headers of the received message 101. After the extraction, control is passed to step S223.

In step S223, the relay program searches the relay setting table 25 using the extracted connection ID as a key, and determines the search result. If an entry storing the connection ID cannot be extracted as a result of the search, it is determined as “not hit”, and control is passed to step S226. On the other hand, if such an entry can be extracted, it is determined as “hit”, and control is passed to step S224.

In step S224, the relay program writes the destination server address (IP address and port number) of the extracted entry as the destination IP address and port number of the L3 and L4 headers of the received message 101, thereby generating the message 201. In the next step S225, the relay program transmits the generated message 201 to the server 3. Then, the primary signal requesting process F22 is terminated.

The message 201 generated in step S224 has the MAC address of the relay device 2 as a source MAC address of the L2 header, and the MAC address of the server 3 to which the message is transferred as a destination MAC address as illustrated in (b) in FIG. 5. The source IP address and port number of the L3 and L4 headers is not rewritten.

In step S226 to which control is passed when it is determined as “not hit” in step S223, the server 3 to which the message 101 (101a) is transferred according to the load balancing algorithm is selected. In the next step S227, the relay program adds one entry to the relay setting table 25, and records the connection ID and the IP address of the selected server 3 in the added entry as the relay setting information. Then, control is passed to step S224.

As described above, a part of the relay unit 21, the load balancing unit 22, and the relay setting record unit 23 of the relay device 2 are realized by performing the primary signal requesting process F22. To be more concrete, a part of the relay unit 21 is realized by performing the processes in steps S221 through S225. The load balancing unit 22 is realized by performing the processes insteps S226, S224, and S225. The relay setting record unit 23 is realized by performing the process in step S227.

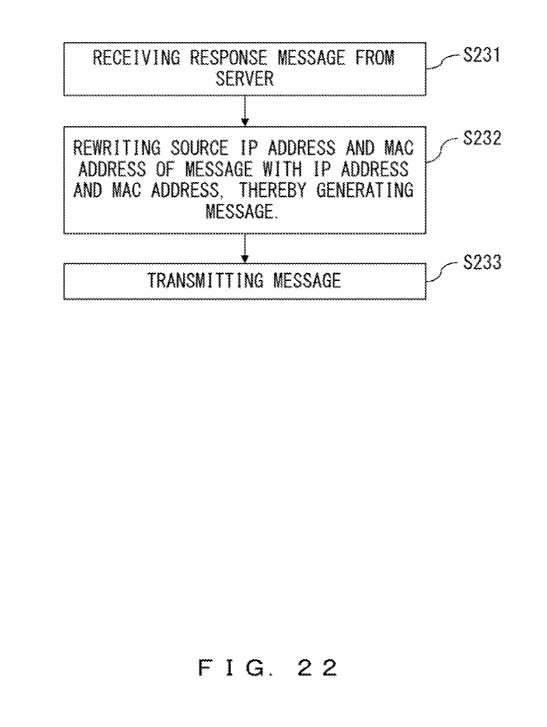

FIG. 22 is a flowchart of the primary signal response process F23. The flowchart in FIG. 22 is also a flow of the process on the message 302 (FIG. 7) received from the server 3. Finally, the primary signal response process F23 is described in detail with reference to FIG. 22. The function of the relay unit 21 which transfers a message from the server 3 to the terminal device 1 is realized by performing the primary signal response process F23.

First in step S231, the relay program waits for the reception of the message 302 from the server 3. Upon receipt of the message 302, control is passed to step S232, an the relay program generates the message 302 (FIG. 6) by rewriting the L2 through L4 headers of the received message 302. In the next step S233, the relay program transmits the generated message 202. After transmitting the message, the primary signal response process is terminated.

In generating the message 202, the MAC addresses of the relay device 2 and the terminal device 1 are stored respectively as the source and destination MAC addresses L of the L2 header of the received message 302. The source IP address and port number of the L3 and L4 headers is changed into the IP address and port number of the relay device 2. Thus, the message 202 is generated from the message 302.

### Second Embodiment

It is preferable that the session ID is unknown to the third party because the third party who knows the session ID can pretend to be a user of the terminal device 1 as a holder of the session ID. Thus, when the session information including the session ID is reported to the route control device 4 by the message 102, it is necessary to guarantee the concealment of the message 102. Therefore, the second embodiment has been devised to guarantee the concealment of the message 102.

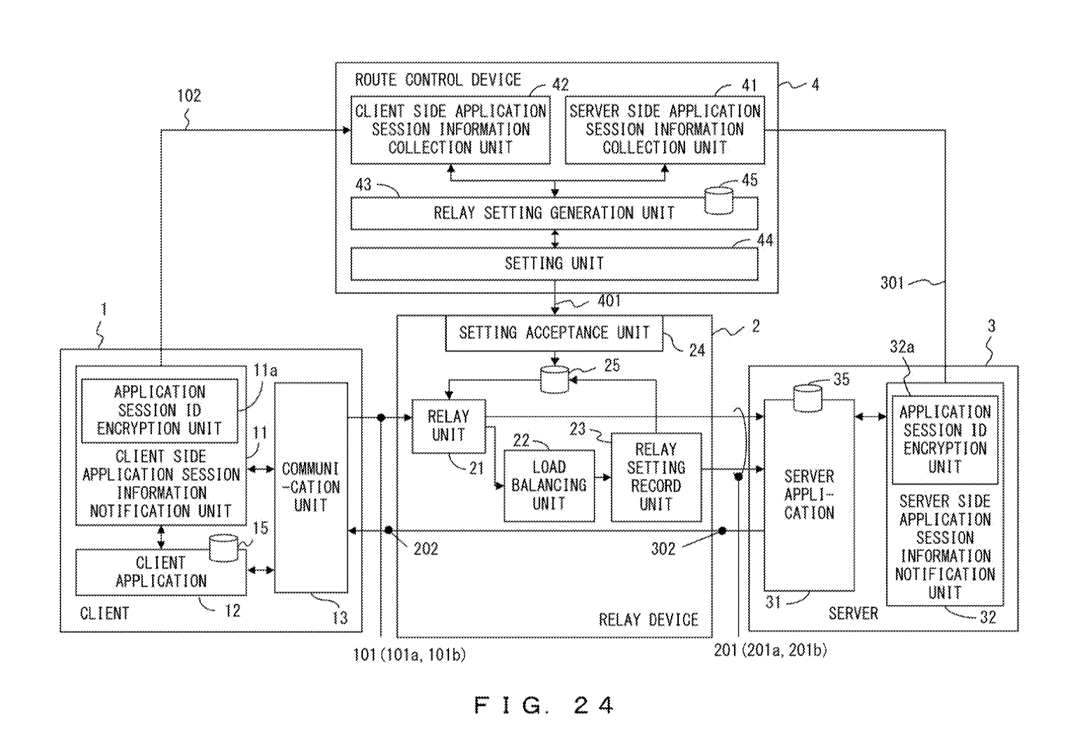

To guarantee the concealment of the message 102, the second embodiment is different in the following points from the first embodiment. The different points are described concretely below with reference to FIG. 24. FIG. 24 is a configuration of the terminal device according to the second embodiment and the service providing system by which a service is available using the terminal device.

The client side application session information notification unit 11 of the terminal device 1 according to the second embodiment includes an application session ID encryption unit 11a as illustrated in FIG. 24. The ID encryption unit 11a encrypts, for example, the payload of the message 102, that is, the session information. Thus, the terminal device 1 transmits the message 102 obtained by encrypting the session information to the route control device 4. The session information is encrypted in, for example, step S115 in the request transmitting process F11 whose flowchart is illustrated in FIG. 15.

The message 102 transmitted from the terminal device is processed by the client side application session information collection unit 42 of the route control device 4. The client side application session information collection unit 42 acquires the session information by decoding the session information of the received message 102, and passes the acquired session information to the relay setting generation unit 43. Thus, the relay setting generation unit 43 generates relay setting information and passes it to the setting unit 44 as in the first embodiment. The session information is decoded in the client side session information collecting process F42 whose flowchart is illustrated in FIG. 19 in, for example, step S421.

In the second embodiment, the terminal device 1 transmits the message 102 obtained by encrypting the session information, and the route control device 4 decodes the session information of the message 102 and sets the relay setting information in the relay device 2. Therefore, the leak of the session information can be more effectively suppressed than in the first embodiment.

As in the server 3, the server side application session information notification unit 32 is provided with an application session ID encryption unit 32a as illustrated in FIG. 24. Thus, the server 3 also transmits the message 301 obtained by encrypting the session information to the route control device 4.

In the second embodiment, the route control device decodes the session information, but it is not always necessary to decode it because when the same data is encrypted by the terminal device 1 and the server 3 under the same rules, the data after the encryption are all the same. Thus, for the session information (for example, it can be configured by a session ID only), the encrypted data can be used instead of the session information if the location of the encrypted data can be specified in advance. When the decoding process is thus avoided, the cost of decoding data can be reduced.

### Third Embodiment

In the first and second embodiments, a notification of session information from the terminal device 1 to the route control device 4 is transmitted by the control of the client application 12. In the third embodiment, a notification of session information is transmitted by the control of software other than the client application 12.

In the third embodiment, only the terminal device 1 is different in the terminal device 1 from the first embodiment. Therefore, the explanation below is concentrated on the terminal device 1. The components also used in the first embodiment are assigned the same reference numerals as in the first embodiment although their operations are different. The session ID of an application is expressed by a “session ID”, and the ID of an SSL session is expressed by an “SSL session ID” for discrimination.

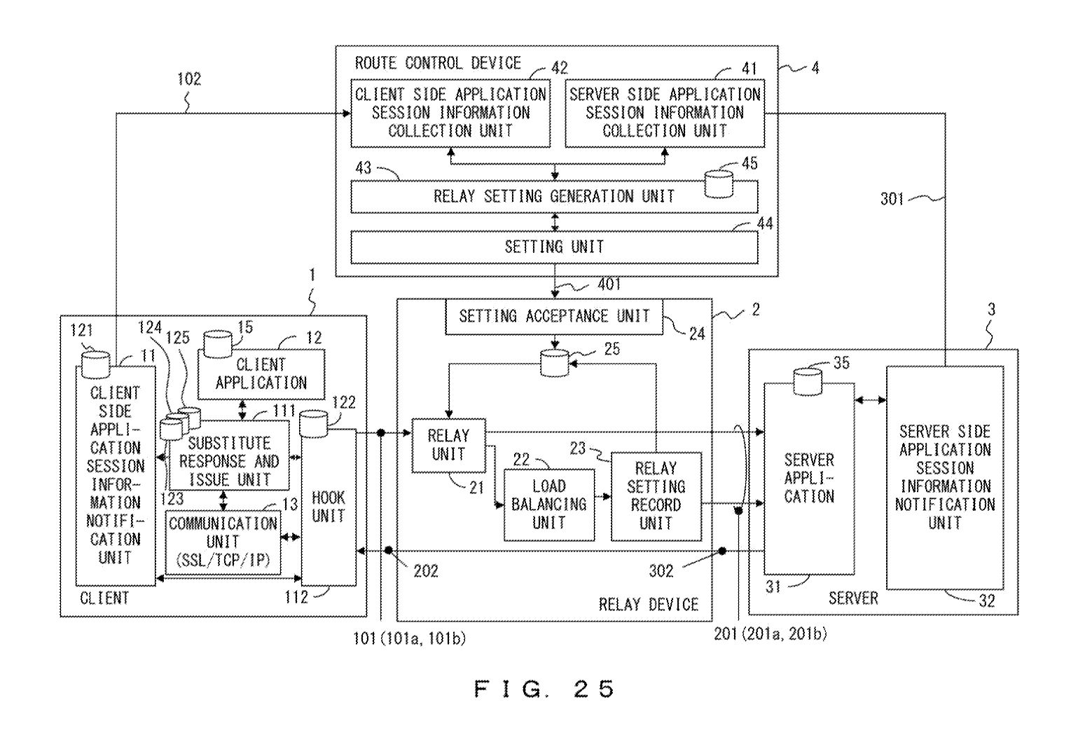

FIG. 25 is a configuration of a terminal device according to the third embodiment and a service providing system capable of using a service through the terminal device. First, the configuration of the function of the terminal device 1 according to the third embodiment is concretely described with reference to FIG. 25.

As illustrated in FIG. 25, the terminal device 1 according to the third embodiment is provided with a substitute response and issue unit 111 and a hook unit 112. The substitute response and issue unit 111 is provided between the client application 12 and the communication unit 13, and controls the communication of a message between the client application 12 and the communication unit 13. The hook unit 112 hooks a predetermined message in the messages output from the communication unit 13 to an external device, and delays the transmission of the predetermined message.

The message 101 is transmitted after an establishment of a connection (TCP connection) to the relay device 2. The establishment of the connection is performed by transmitting a SYN packet (packet with an SYN flag) for a request of the establishment. An SSL session is established after the establishment of the connection. In the present embodiment, the hook unit 112 is directed to hook the SYN packet as a predetermined message. Thus, the substitute response and request unit 111 and the hook unit 112 control the timing of practically transmitting a message requested by the client application 12 for the transmission the message, acquire the session information, and notify the route control device 4 of the acquired session information. By controlling the timing of transmitting the requested message, the substitute response and request unit 111 are substitutes for transmitting a response to the client application 12. The operations are described below mainly on the substitute response and request unit 111 and the hook unit 112.

Before transmitting the message 101, the client application 12 requests to establish an SSL session (hereinafter referred to as an “SSL communication path”) as a provisional communication path by specifying the destination IP address and port number to which the message 101 is to be transmitted. Upon receipt of the request, the substitute response and request unit 111 generates a temporary connection ID (hereinafter referred to as a “provisional connection ID”) and a temporary SSL session ID (hereinafter referred to as a “provisional SSL session ID”), and the generated IDs are returned as a response.

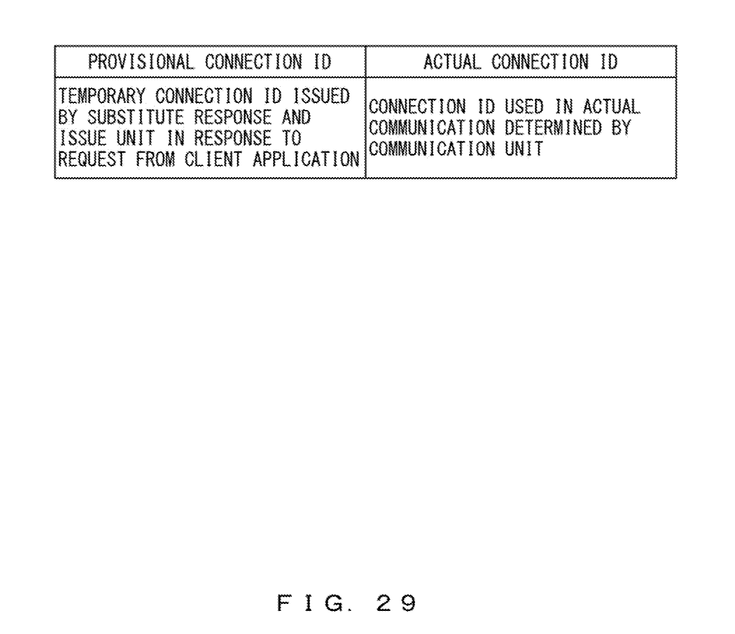

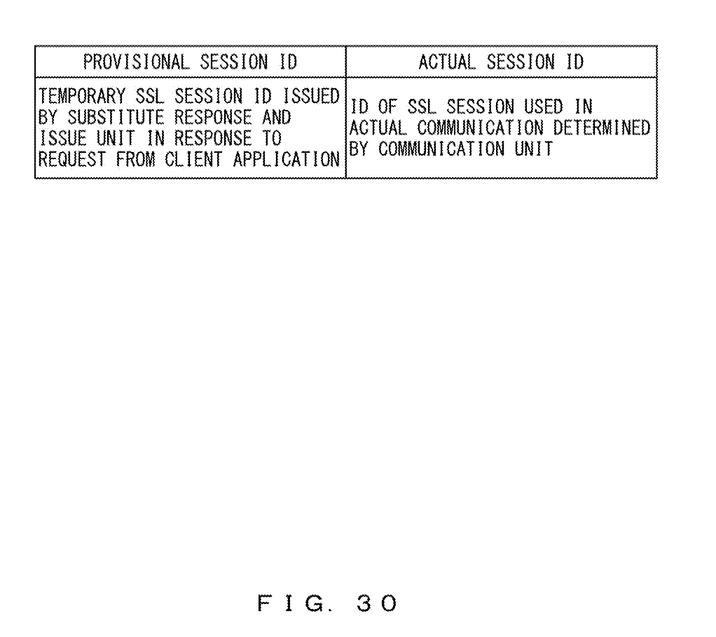

The generated provisional connection ID and the provisional SSL session ID are not always used in a practical transmission. Therefore, the substitute response and request unit 111 stores the results of generating the provisional connection ID and the provisional SSL session ID in a connection ID mapping table 124 and a SSL session ID mapping table 125 respectively. The connection ID mapping table 124 is prepared to specify the correspondence between a provisional connection ID and a practical connection ID (hereinafter referred to as an “actual connection ID”). As illustrated in FIG. 29, an entry stores a provisional connection ID and an actual connection ID. Similarly, the SSL session ID mapping table 125 is prepared to specify the correspondence between a provisional SSL session ID and a practical SSL session ID (hereinafter referred to as an “actual SSL session ID”). As illustrated in FIG. 30, one entry stores a provisional SSL session ID and an actual SSL session ID.

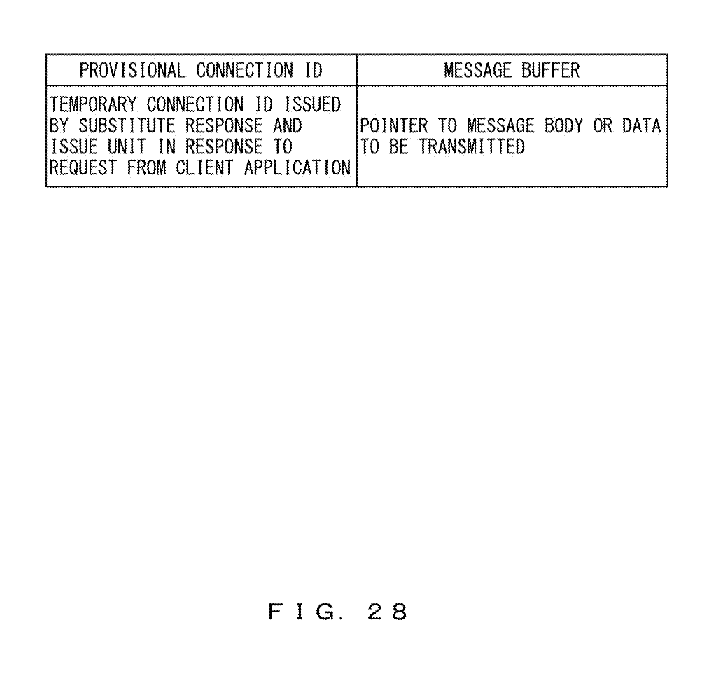

After receiving a provisional connection ID and a provisional SSL session ID as a response, the client application determines that the SSL communication path has been established, and requests to transmit the message 101 using the received IDs. The message 101 stores the provisional connection ID in the L3 and L4 headers. Upon receipt of a request to transmit the message 101 from the client application 12, the substitute response and issue unit 111 extracts as provisional connection IDs the source and destination IP addresses and port numbers stored in the L3 and L4 headers of the message 101. Next, it searches the SSL session ID mapping table 125 using the extracted provisional connection IDs as keys, extracts an entry storing the provisional connection ID, and confirms whether or not an actual connection ID is stored in the entry. If no actual connection ID is confirmed, it is determined that an SSL communication path (including a TCP connection) is not practically established, and the message 101 is stored, and a request to establish an SSL communication path is issued to the communication unit 13. The message 101 is stored using a message buffer table 123. An entry of the table 123 stores the provisional connection ID, the message 101 body, or a pointer as data indicating the storage location of the message 101 as illustrated in FIG. 28.

At the request for the SSL communication path, the communication unit 13 generates and outputs a SYN packet as a message requesting the relay device 2 to establish an SSL communication path. Thus, the substitute response and issue unit 111 directs the hook unit 112 to hook the SYN packet. On the other hand, if the actual connection ID is conformed, the substitute response and issue unit 111 passes the message 101 to the communication unit 13, and requests to transmit the message 101.

The direction to hook the SYN packet is issued by specifying the destination IP address and port number of the L3 and L4 headers of the packet. The hook unit 112 registers the destination IP address and port number specified by the substitute response and issue unit 111 in a hook target list (table) 122. Thus, upon receipt of the message from the communication unit 13, the hook unit 112 extracts the destination IP address and port number of the L3 and L4 headers of the message, and confirms whether or not the extracted destination IP address and port number has been registered in the hook target list 122. By the confirmation, a message including the destination IP address and port number registered in the hook target list 122 is hooked.

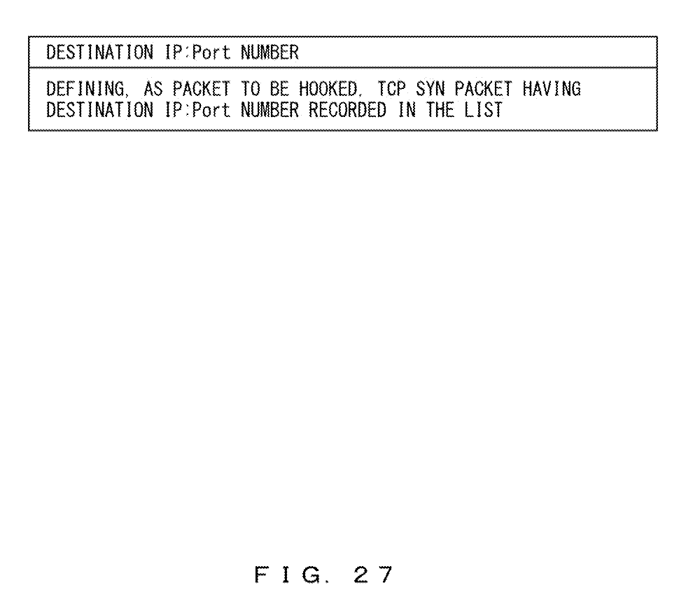

FIG. 27 is an explanatory view of the data stored in one entry of a hook target list. As illustrated in FIG. 27, one entry of the hook target list 122 stores the destination IP address and port number specified by the substitute response and issue unit 111 as the information for identification of a message (packet) to be hooked.

The connection ID stored as the source and destination IP addresses and port numbers in the L3 and L4 headers of the message passed from the communication unit 13 to the hook unit 112 is an actual connection ID. Therefore, when the hook unit 112 hooks a message, it extracts the connection ID of the hooked message, and notifies the client side application session information notification unit 11 of the extracted connection ID as an actual connection ID. After the notification, the hook is released, and the hooked message is transmitted.

After directing the hook unit 112 to hook the message, the substitute response and issue unit 111 acquires an actual connection ID and an actual SSL session ID from the communication unit 13 which is requested to transmit the message. The acquired actual connection ID is stored in the entry extracted from the SSL session ID mapping table 125 using the provisional connection ID as a key. The acquired actual SSL session ID is stored in the entry extracted from the SSL session ID mapping table 125 using the provisional SSL session ID specified by the client application 12 as a key. Thus, the correspondences between the provisional connection ID and the actual connection ID, and between the provisional SSL session ID and the actual SSL session ID are established.

The message passed from the client application 12 to the substitute response and issue unit 111 has not been encrypted. Under the situation, in the present embodiment, when no actual connection ID is stored in the entry extracted from the SSL session ID mapping table 125 using a provisional connection ID as a key, it is confirmed whether or not the session ID is stored in the message. Only when the session ID is stored, the substitute response and issue unit 111 directs to hook the message. The session ID is reported together with the destination IP address and port number to the client side application session information notification unit 11 before directing the hook.

As described above, after the substitute response and issue unit 111 notifies the client side application session information notification unit 11 of the session ID and the destination IP address and port number, the hook unit 112 notifies the client side application session information notification unit 11 of the actual connection ID. Upon receipt of the notification of the actual connection ID, the client side application session information notification unit 11 notifies the route control device 4 of the session information. For the notification of the session information, a session information management table 121 is managed.

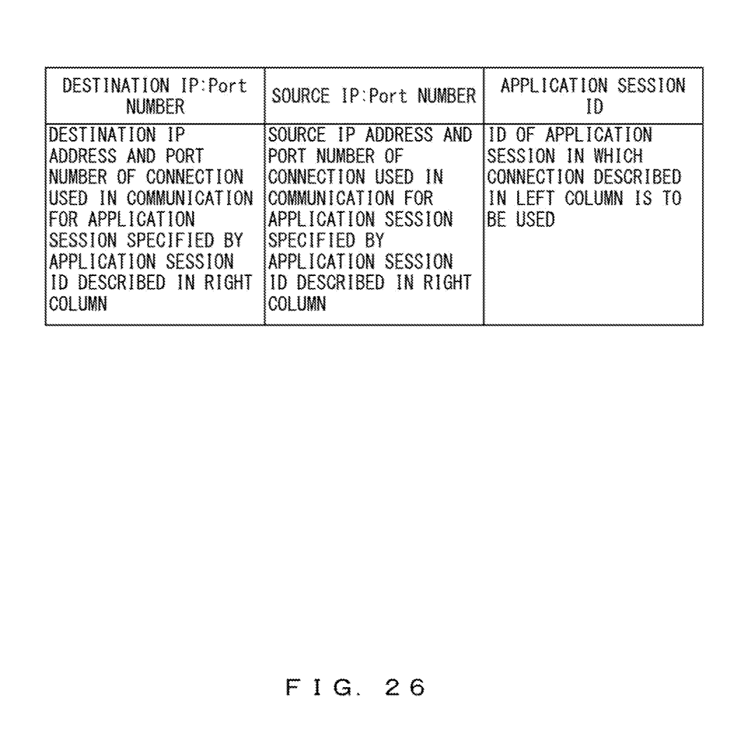

FIG. 26 is an explanatory view of the data stored in one entry of the session information management table. As illustrated in FIG. 26, one entry stores a destination IP address and port number, a source IP address and port number, and a session ID. The destination IP address and port number and the source IP address and port number refer to an actual connection ID.

When the hook unit 112 transmits a hooked message (SYN packet), a TCP connection and an SSL communication path are established with the relay device 2. The establishment is performed by the control of the communication unit 13, and the communication unit 13 notifies the substitute response and issue unit 111 of the establishment of the SSL communication path. When the notification is transmitted, an actual connection ID and an actual SSL session ID are acquired.

As described above, the substitute response and issue unit 111 and the hook unit 112 adjust the collection of the session information to be reported to the route control device 4, and the transmission timing of the message required to report the collected session information. Thus, the client application 12 which is not provided with a special function is available. Accordingly, the substitute response and issue unit 111 and the hook unit 112 realize the terminal device 1 according to the present embodiment by being loaded into a conventional terminal device.

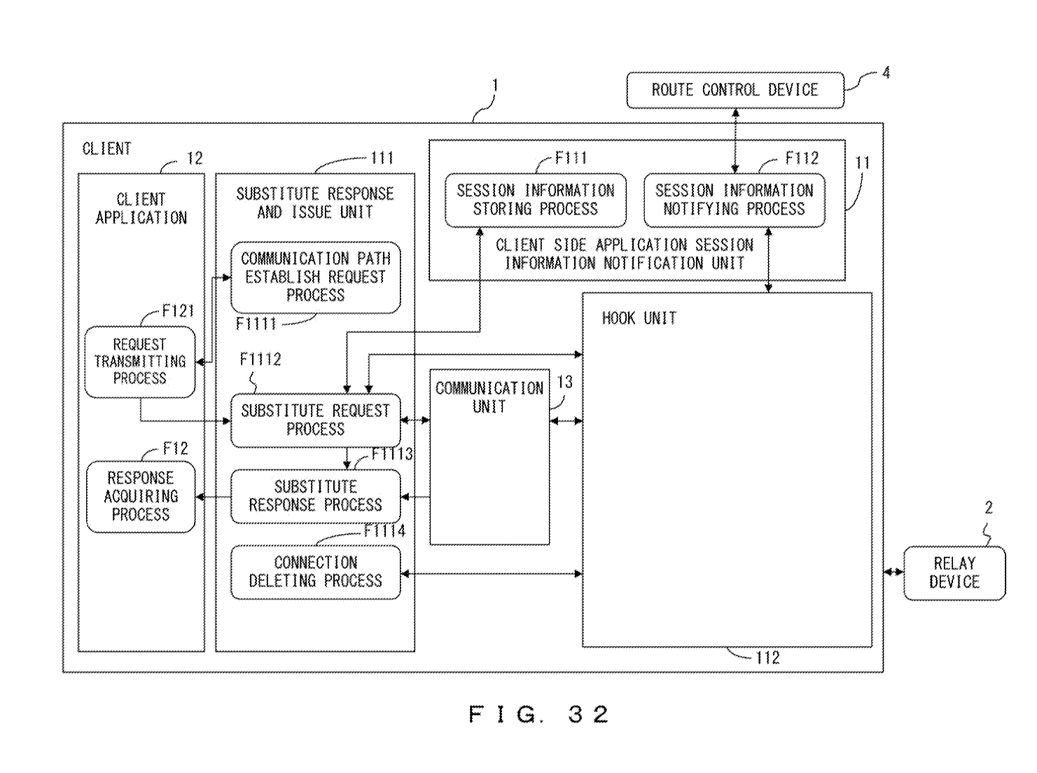

FIG. 32 is an explanatory view of the process realized by a program executed by the terminal device 1 according to the third embodiment. The program executed by the terminal device 1 and the process realized by each program are described below with reference to FIG. 32.

The terminal device 1 according to the third embodiment executes, in addition to the client application 12, the program for realizing the client side application session information notification unit 11 (hereinafter referred to as a “session information notifying program”), and the program for realizing the hook unit 112 (hereinafter referred to as a “hook program”).

The communication unit 13 is realized by an OS (operating system). A program such as an application etc. can be executed based on the operation of the OS. Therefore, the OS, that is, the communication unit 13, is a program executed by the terminal device 1, and the detailed description is omitted here. The session information notifying program, the substitute response program, and the hook program are provided as, for example, middleware.

The client application 12 performs a request transmitting process F121 and the response acquiring process F12. The request transmitting process F121 is a process for transmitting the message 101 as a request. The response acquiring process F12 is a process performed on the message (message 102) transmitted as a response to the message 101, and the contents are basically the same as those according to the first embodiment (FIG. 16). Therefore, the detailed descriptions are omitted here.

The substitute response program realizes a communication path establish request response process F1111, a substitute request process F1112, a substitute response process F1113, and a connection delete request process F1114. The communication path establish request response process F1111 is a process corresponding to the request to establish an SSL communication path performed by the client application 12. The substitute request process F1112 is a process corresponding to the request to transmit the message 101 performed by the client application 12 after the request to establish an SSL communication path. The substitute response process F1113 is a process of transmitting to the client application 12 a message (message 202) received as a response to the transmission of the message 101. The established TCP connection is released by the disconnection procedure from the side where there is no data to be transmitted. When the release is performed, a FIN packet (a message with a FIN flag for requesting a disconnection) is transmitted. The connection delete request process F1114 is a process for receiving a FIN packet. When the message 101 is transmitted, the server 3 transmits the message 302, and the terminal device 1 normally receives the FIN packet through the relay device 2.

A session information notifying program realizes a session information storing process F111 and a session information notifying process F112. The session information storing process F111 is a process for storing the session information reported from the substitute response and issue unit 111. The session information notifying process F112 is a process for notifying the route control device 4 of the session information.

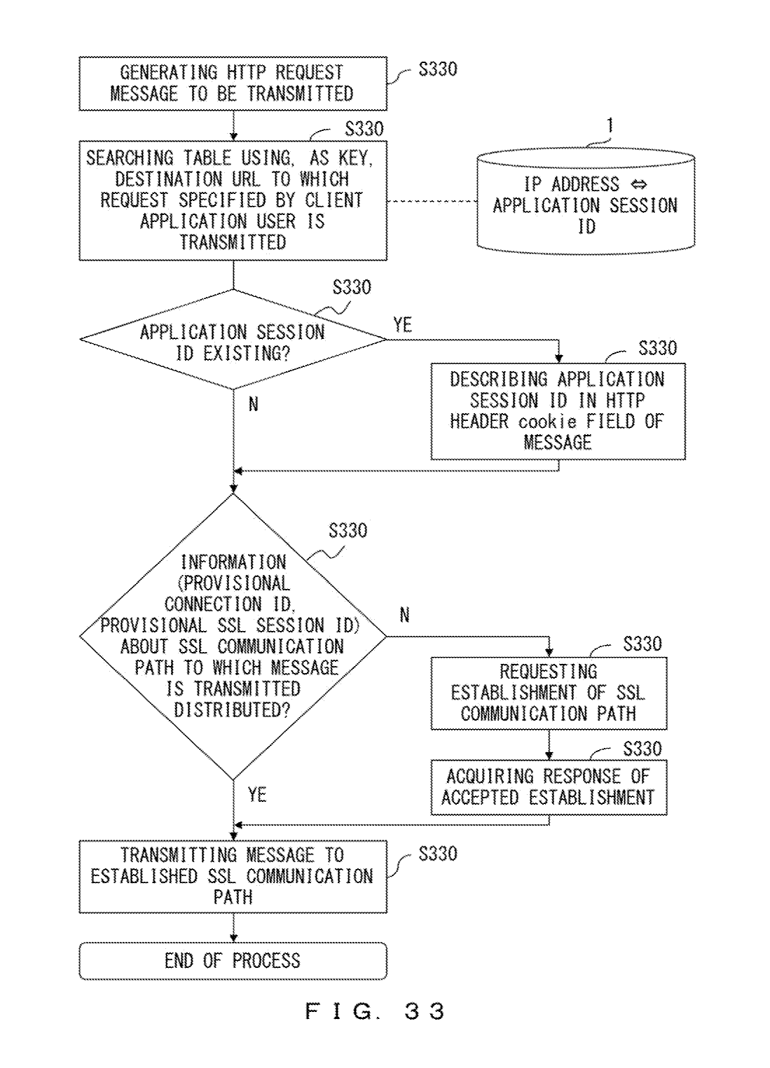

Each process illustrated in FIG. 32 is described below in detail with reference to each flowchart illustrated in FIGS. 33 through 39.

First, the request transmitting process F121 realized by the client application 12 is described in detail with reference to the flowchart illustrated in FIG. 33. As with the first embodiment, the transmitting process F121 is also executed when a user directs access to a service providing system, that is, when the user directs a transmission of the message 101 to the service providing system.

First in step S3301, the client application 12 generates the message 101 at an instruction of the user. In the next step S3302, the session ID table 15 (FIG. 10) is searched using a user-specified URL (destination URL) as a key. In the next step S3303, the client application 12 determines from the search result whether or not there is a session ID corresponding to the URL (IP address and port number) used as a key. If an entry storing the URL used as a key has been extracted as a result of the search, then the determination is YES, control is passed to step S3304, and the client application 12 describes the session ID in the message 101. Then, control is passed to step S3305. On the other hand, if no such entry has been extracted, the determination is NO, and control is passed to step S3305.

In step S3305, the client application 12 determines whether or not the information about the SSL communication path for transmission of the message (request) 101 has been distributed. As described above, the information returned by the substitute response and issue unit 111 to the client application 12 at the request to establish an SSL communication path is a provisional connection ID and a provisional SSL session ID. Therefore, when there are valid provisional connection ID and provisional SSL session ID, the determination is YES, control is passed to step S3306, and the client application 12 transmits the generated message 101 together with the provisional SSL session ID to the substitute response and issue unit 111. Then, the request transmitting process is terminated. On the other hand, if there is no valid provisional connection ID or provisional SSL session ID, the determination is NO, and control is passed to step S3307.

In step S3307, the client application 12 requests the substitute response and issue unit 111 to establish an SSL communication path. In the next step S3308, the client application 12 waits for the response to the establish request, that is, a provisional connection ID and a provisional SSL session ID, from the substitute response and issue unit 111. After the acquisition of the response, control is passed to step S3306.

The message 101 in step S3306 and the request to establish an SSL communication path in step S3307 are transmitted to the substitute response and issue unit 111. However, the message 101 and the request to establish the path are processed by the client application 12 as if they were issued to the communication unit 13. Thus, the client application 12 has no special function for the substitute response and issue unit 111.

Described next in detail are the communication path establish request response process F1111, the substitute request process F1112, the substitute response process F1113, and the connection delete request process F1114 realized by the substitute response program.

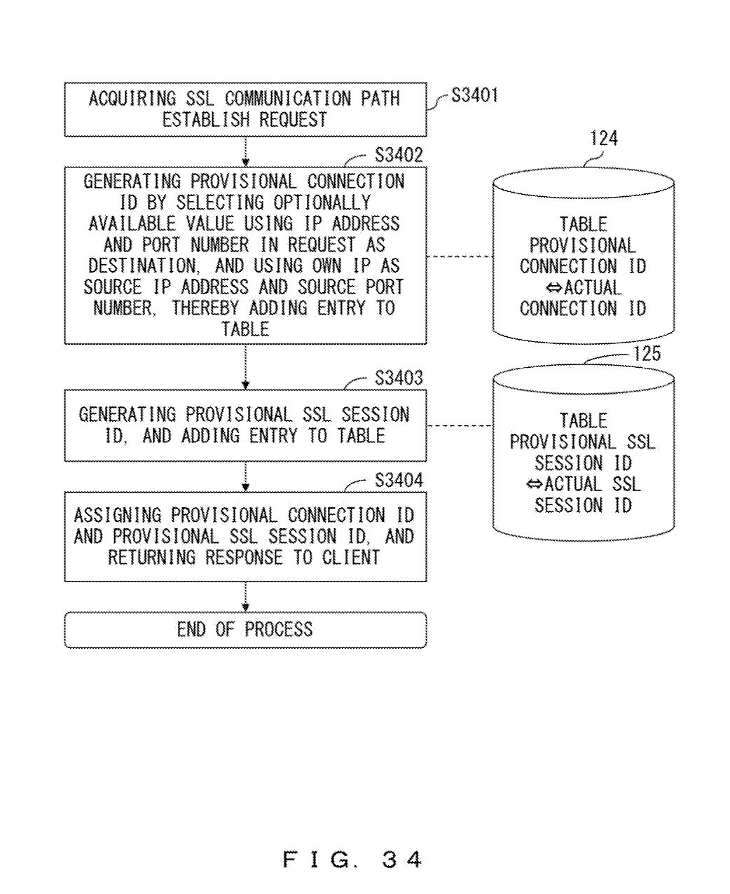

FIG. 34 is a flowchart of the communication path establishment request response process. First, the request response process F1111 is described in detail with reference to FIG. 34. The flowchart in FIG. 34 is a flow of the process performed on a request to establish an SSL communication path from the client application 12.

First, in step S3401, the substitute response program acquires a destination IP address and port number from the request to establish an SSL communication path. In the next step S3402, the substitute response program generates a provisional connection ID, adds an entry to the connection ID mapping table 124, and stores the generated provisional connection ID in the entry. The provisional connection ID is the IP address of the terminal device 1 and the port number selected from the available port numbers as the source IP address and port number and the acquired destination IP address and port number. After storing the provisional connection ID, control is passed to step S3403.

In step S3403, a provisional SSL session ID is generated, and an entry storing the generated provisional SSL session ID is added to the SSL session ID mapping table 125. In the next step S3404, the generated provisional connection ID and provisional SSL session ID are returned to the client application 12 as a response. Then, the communication path establishment request response process is terminated.

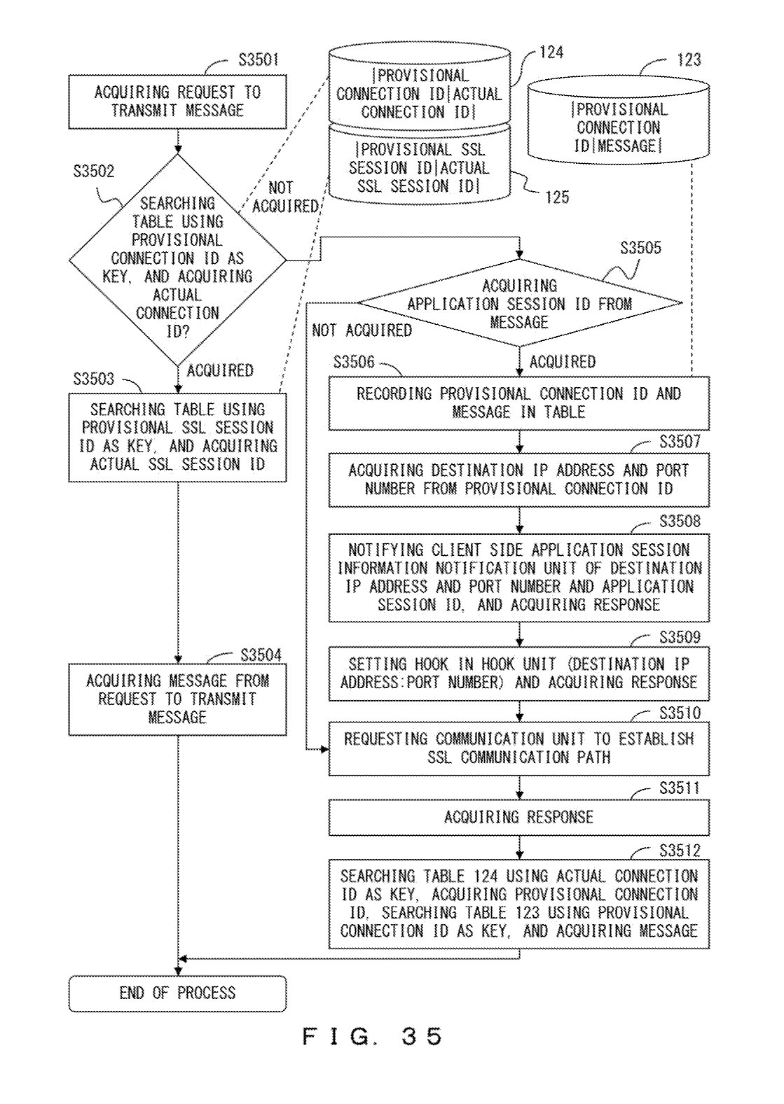

FIG. 35 is a flowchart of the substitute requesting process. Next, the request process F1112 is described in detail with reference to FIG. 35. The flowchart in FIG. 35 is a flow of the process performed on the request to transmit a message 101 from the client application 12.

First in step S3501, the substitute response program acquires a provisional connection ID from the L3 and L4 headers of the message 101 received as a request to transmit a message from the client application 12. In the next step S3502, it is determined whether or not an actual connection ID has been acquired by searching the connection ID mapping table 124 using the acquired provisional connection ID as a key. If the entry extracted by the search stores an actual connection ID, it is determined that the actual connection ID has been acquired, and control is passed to step S3503. If the extracted entry stores no actual connection ID, it is determined that an actual connection ID has not been acquired, control is passed to step S3505.

In step S3503, the substitute response program acquires an actual SSL session ID by searching the SSL session ID mapping table 125 using the provisional SSL session ID from the client application 12 as a key. In the next step S3504, the substitute response program acquires the message 101 in the request to transmit a message, and sets the message 101 as a message to be transmitted. After the setting, the substitute request process F1112 is terminated.

In step S3505 to which control is passed when it is determined in step S3502 that an actual connection ID has not been acquired, the substitute response program determines whether or not a session ID has been acquired from the message 101. If the HTTP header of the message 101 stores a session ID, it is determined that a session ID has been acquired, and control is passed to step S3506. If a session ID is not stored in the message 101, it is determined that a session ID has not been acquired, and control is passed to step S3510.

In step S3506, the substitute response program adds to the message buffer table 123 an entry storing a provisional connection ID extracted from the message 101, and the message 101, or its pointer. In the next step S3507, the substitute response program acquires the destination IP address and port number of the provisional connection ID. In the next step S3508, the substitute response program notifies the client side application session information notification unit 11 of the acquired destination IP address and port number together with the session ID, and the response is acquired. After acquiring the response, control is passed to step S3509.

In step S3509, the substitute response program performs a hook setting by notifying the hook unit 112 of the destination IP address and port number acquired in step S3507. In the next step S3510, the substitute response program passes the destination IP address and port number to the communication unit 13, and issues a request to establish an SSL communication path. In the next step S3511, the substitute response program acquires a response including an actual connection ID and an actual SSL session ID, and stores the actual connection ID and the actual SSL session ID.

The actual connection ID is stored by writing the actual connection ID in an entry storing the provisional connection ID passed from the client application 12 in the connection ID mapping table 124. The actual SSL session ID is similarly stored by writing the actual SSL session ID in an entry storing the provisional connection ID passed from the client application 12 in the SSL session ID mapping table 125.

After storing the actual connection ID and the actual SSL session ID, control is passed to step S3512. In step S3512, the substitute response program acquires the message 101 stored in step S3506. The message 101 is acquired by extracting a provisional connection ID by searching the connection ID mapping table 124 using the acquired actual connection ID as a key, and extracting the message 101 itself or a pointer by searching the message buffer table 123 using the provisional connection ID as a key. After the thus acquired message 101 is set as a message to be transmitted, the substitute request process F1112 is terminated.

As described above, the session information is reported to the route control device 4 when an actual connection ID is generated on condition that an SSL communication path is not maintained in the present embodiment because it is assumed that the time required to maintain an SSL communication path is shorter than the time required to maintain a session. That is, although an established SSL communication path is available, it is possible that a session is maintained in the server 3.

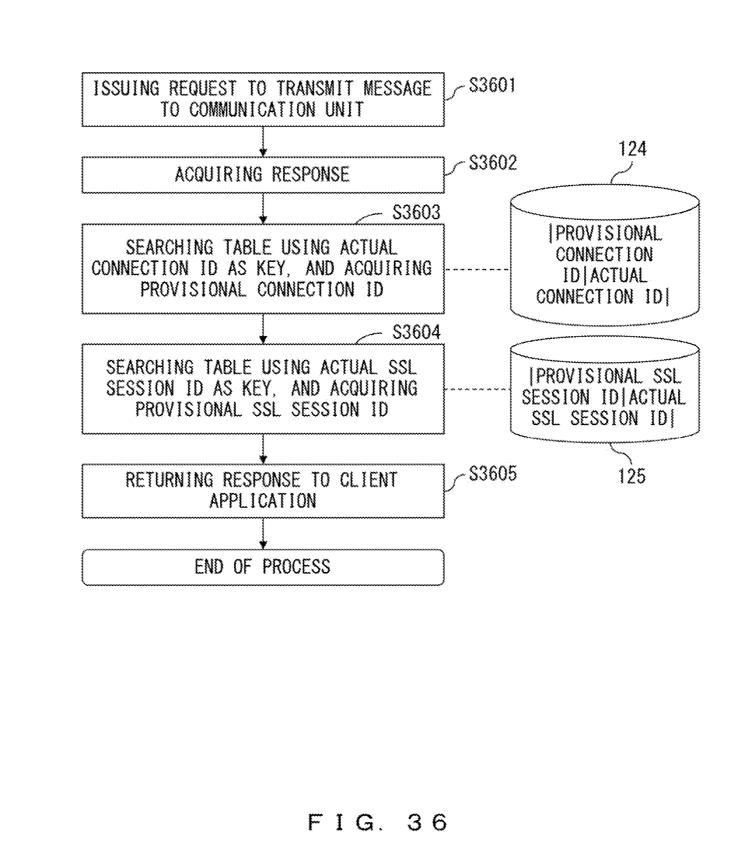

FIG. 36 is a flowchart of the substitute response process. The substitute response process F1113 is described below in detail with reference to FIG. 36. The substitute response process F1113 is a process activated after the termination of the substitute request process F1112, and the flowchart in FIG. 36 is a flow of the process performed in transmitting the message 101 set as a message to be transmitted by the substitute request process F1112.

First in step S3601, the substitute response program issues a request to transmit a message to the communication unit 13. In the next step S3602, the substitute response program acquires a response from the communication unit 13. The response includes the message 202. After acquiring the response, control is passed to step S3603.

In step S3603, the substitute response program acquires a provisional connection ID by searching the connection ID mapping table 124 using the actual connection ID stored in the L3 and L4 headers as a key. In the next step S3604, the substitute response program acquires a provisional SSL session ID by searching the SSL session ID mapping table 125 using the actual SSL session ID as a key. In the next step S3605, the substitute response program returns a response to the client application 12. Then, the substitute response process F1113 is terminated.

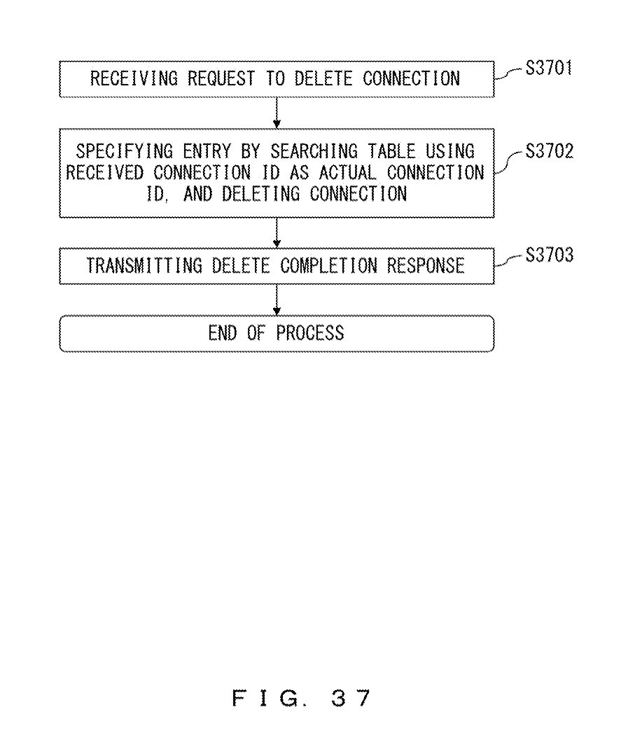

FIG. 37 is a flowchart of the connection deleting process. Finally, the delete request process F1114 is described in detail with reference to FIG. 37.

As described above, the established TCP connection is started by transmitting a FIN packet (message with a FIN flag requesting a disconnection) from the side where there is no data to be transmitted. The side which has received the FIN packet transmits the FIN packet when there becomes no data to be transmitted, and the connection is released when the communication of the packet is completed. Since the terminal device 1 is the side which requests data, the FIN packet is a trigger for a disconnection. The connection delete request process F1114 is a process performed to receive the FIN packet. The flowchart in FIG. 37 is a flow of the process performed to receive a FIN packet.

First in step S3701, the substitute response program receives a request to delete a TCP connection. The reception of the delete request corresponds to acquiring a FIN packet from the communication unit 13.

After receiving the delete request, control is passed to step S3702, and the substitute response program extracts an entry by searching the connection ID mapping table 124 using the actual connection ID stored in the L3 and L4 headers of the FIN packet as a key, and deletes the entry from the table 124. In the next step S3703, the substitute response program returns the delete completion response to the communication unit 13 to notify that the actual connection has been deleted. Then, the connection delete request process F1114 is terminated.

The thus established TCP connection is released each time the communication of data between the terminal device 1 and the server 3 terminates. Therefore, regardless of whether or not the SSL communication path is maintained, the establishment of the TCP connection is performed when the message 101 is transmitted.

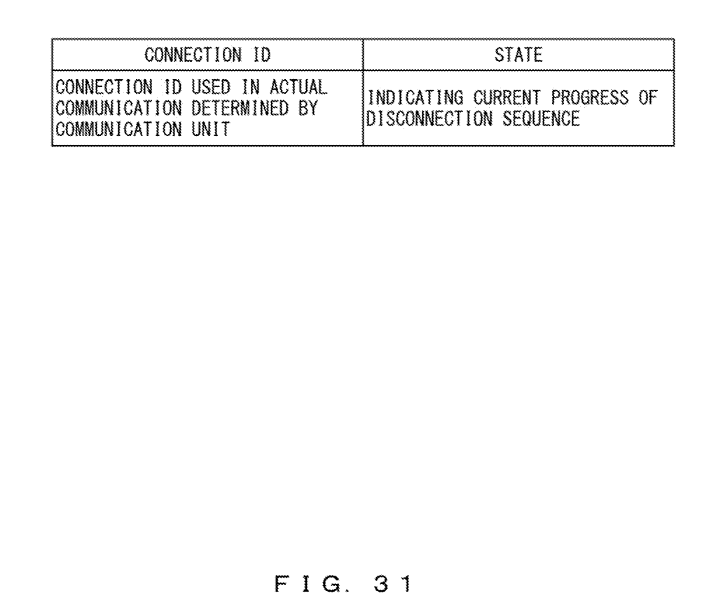

The TCP connection is released in a predetermined procedure. Therefore, the hook unit 112 prepares a connection management table not illustrated in the attached drawings to determine the timing of outputting the FIN packet to the substitute response and issue unit 111. The management table stores an actual connection ID and (the data indicating) the state of the connection in each entry as illustrated in FIG. 31. Thus, the hook unit 112 grasps the status and the transition of the status for each actual connection, and outputs to the substitute response and issue unit 111 the final message from the server 3 for a release of the TCP connection.

Finally, the session information storing process F111 and the session information notifying process F112 realized by the session information notifying program are described below in detail.

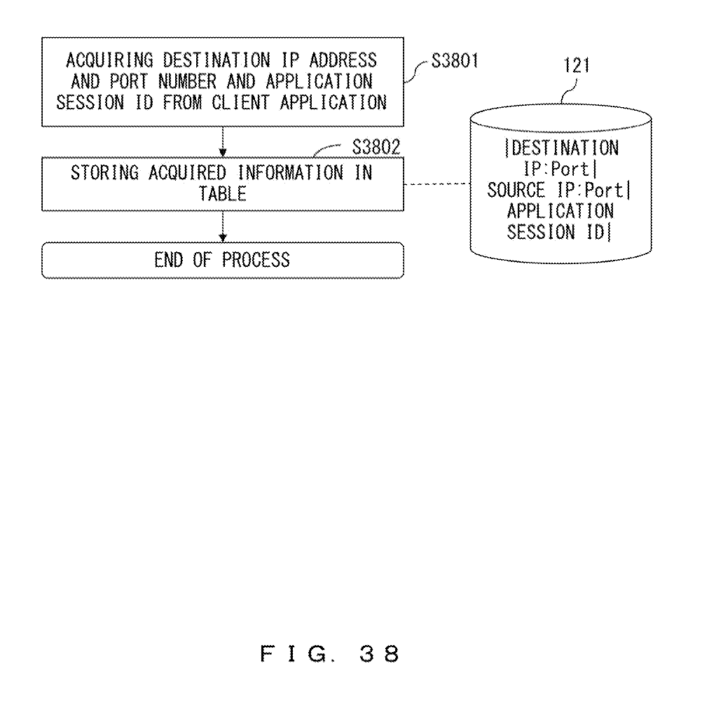

FIG. 38 is a flowchart of the session information storing process. The storing process F111 is a process for storing the session information notified from the substitute response and issue unit 111. The notification is realized by the substitute response program performing the process in step S3508. FIG. 38 illustrates the flow of the process performed for storing one piece of session information. First, the storing process F111 is described in detail with reference to FIG. 38.

First, in step S3801, the session information notifying program acquires the session information notified from the substitute response program, that is, the destination IP address and port number and the session ID. In the next step S3802, the session information notifying program stores the notified session information in the session information management table 121. The information is stored by searching the session information management table 121 using, for example, a session ID as a key, extracting an entry by the search, and storing the session information in the extracted entry. If no entry is extracted, one entry is added, and the session information is stored in the added entry. Thus, after the session information is stored, the session information storing process F111 is terminated.

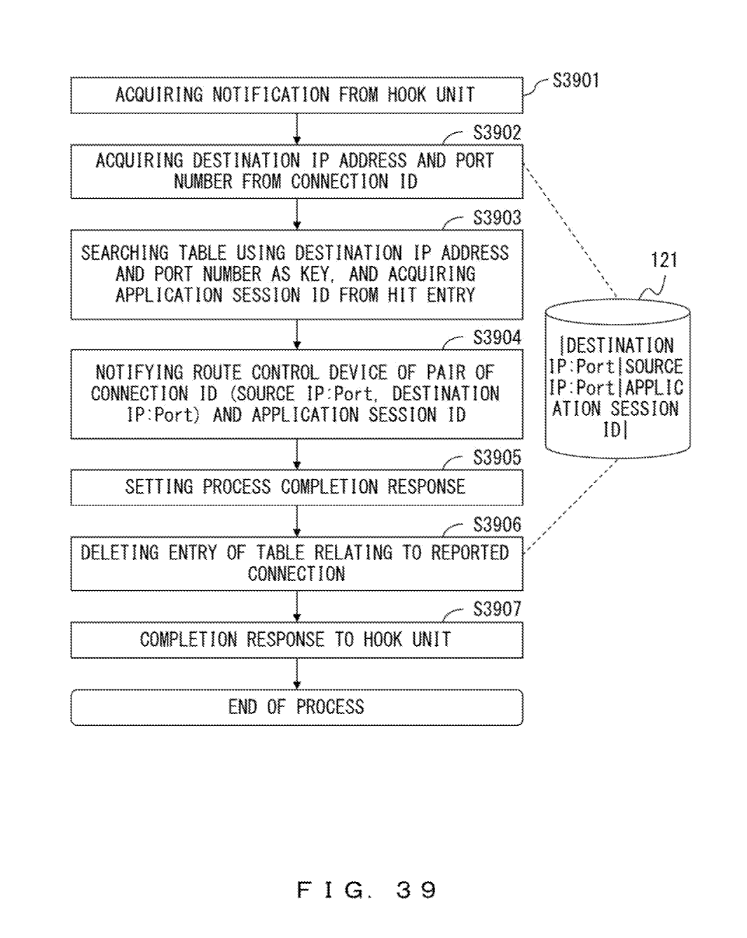

FIG. 39 is a flowchart of the session information notifying process. The notifying process F112 is a process for notifying the route control device 4 of the session information. The flowchart in FIG. 39 is a flow of the process performed to notify the route control device 4 of one piece of session information. Finally, the notifying process is described in detail with reference to FIG. 39.

The hook unit 112 hooks the SYN packet specified by the substitute response program performing the process in step S3509 in FIG. 35. When the SYN packet is hooked, the hook unit 112 notifies the client side application session information notification unit 11 of the actual connection ID stored in the L3 and L4 headers of the SYN packet before transmitting the SYN packet. The session information notifying process F112 is triggered by the notification of the actual connection ID.

First in step S3901, the session information notifying program acquires the actual connection ID notified from the hook unit 112. In the next step S3902, the session information notifying program acquires the destination IP address and port number from the actual connection ID. In the next step S3903, the session information notifying program searches the session information management table 121 using the acquired destination IP address and port number as a key, and acquires a session ID from an entry extracted by the search. The entry stores the source IP address and port number acquired from the actual connection ID. Then, control is passed to step S3904.

In step S3904, the session information notifying program notifies the route control device 4 of the acquired actual connection ID and the session ID as session information. The notification is performed by generating and transmitting the message 102 (FIG. 4) as in the first embodiment. After the route control device 4 receives the message 102, it sets relay setting information in the relay device 2, and transmits to the terminal device 1a setting completion notification as a message reporting the completion of the setting. Accordingly, in the next step S3905, the session information notifying program acquires a setting completion notification. After the acquisition of the setting completion notification, control is passed to step S3906.

In step S3906, the session information notifying program deletes the entry storing the session information reported to the route control device 4 from the session information management table 121. In step S3907, the session information notifying program returns to the hook unit 112 a response to the notification of the actual connection ID. Then, the session information notifying process F112 is terminated. After the acquisition of the response, the hook unit 112 transmits the hooked SYN packet.

In the third embodiment, a program (for example, middleware) is prepared in addition to the client application 12, and the substitute response and issue unit 111 and the hook unit 112 are prepared. The function of realizing them can be loaded into the client application 12. In this case, session information can be reported to the route control device 4 without generating a provisional connection ID and/or provisional SSL session ID. In the present embodiment (first through third embodiments), session information is reported from the terminal device 1 not only when the message 101 is transmitted, but also when the response of the initial message 101a is received. Other variations are available.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a program that causes a computer to perform a procedure, the procedure comprising:
confirming presence/absence of session data received from a server when a message is transmitted to the server through a relay device;
generating connection data when the session data exists;
transmitting the session data and the connection data to a route control device;
generating transmission data to be transmitted to the server and encryption data obtained by encrypting the session data when a notification of completion of a relay setting of the relay device is received from the route control device; and
transmitting a message including the connection data and the encryption data to the relay device.

2. The storage medium according to claim 1, wherein
when the session data and the connection data are transmitted to the route control device, the session data is encrypted.

3. A computer readable, non-transitory medium storing a program used to direct a computer to perform a procedure, the procedure comprising:
generating connection data for a connection when the connection is established to transmit a message to a server through a relay device;
confirming presence/absence of session data received from the server;
transmitting the session data and the connection data to a route control device when the session data exists;
encrypting transmission data to be transmitted to the server in the message and the session data and generating encryption data when a notification of completion of a relay setting of the relay device is received from the route control device; and
transmitting a message including the connection data and the encryption data to the relay device.

4. A computer readable, non-transitory medium storing a program used to direct a computer to perform a procedure, the procedure comprising:
receiving session data and connection data from an information processing device;
extracting a server address based on the session data; and
transmitting the connection data and the server address to a relay device.

5. The storage medium according to claim 4, wherein
the session data received from the information processing device is encrypted.

6. An information processing device, comprising:
a route notification unit which confirms presence/absence of session data received from a server, and generates connection data when the session data exists, and transmits the session data and the connection data to the route control device; and
a transmission unit which generates encryption data by encrypting transmission data to be transmitted to the server and the session data when a notification of completion of a relay setting of a relay device is received from the route control device, and transmits a message including the connection data and the encryption data to the relay device.

7. The device according to claim 6, wherein
the route notification unit encrypts the session data to be transmitted to the route control device.

8. (canceled)

9. An information processing device, comprising:
a route notification unit which generates connection data for a connection when the connection is established to transmit a message to a server through a relay device, confirms presence/absence of session data received from the server, and transmits the session data and the connection data to a route control device when the session data exists; and
a transmission unit which encrypts transmission data to be transmitted to the server in the message and the session data and generates encryption data when a notification of completion of a relay setting of the relay device is received from the route control device, and transmits a message including the connection data and the encryption data to the relay device.

10. (canceled)

11. A route control device, comprising:
a relay setting generation unit which receives session data and connection data from an information processing device, and extracts a server address based on the session data; and
a setting unit which transmits the connection data and the server address to a relay device.

12. (canceled)

13. A data relay method, comprising:
confirming, by an information processing device, presence/absence of session data received from a server;
generating, by the information processing device, connection data when the session data exists;
transmitting, by the information processing device, the session data and the connection data to a route control device;
extracting, by the route control device, a server address of the server based on the received session data;
transmitting the connection data and the server address to a relay device;
generating, by the route control device, encryption data by encrypting transmission data to be transmitted to the server and the session data when a notification of completion of a relay setting of the relay device from the route control device;
transmitting, by the information processing device, a message including the connection data and the encryption data to the relay device;
extracting, by the relay device, the server address based on the connection data in the received message; and
transmitting, by the relay device, the message to the extracted server address.
